(19) United States
(12) Patent Application Publication
(10) Pub. No.: US 2021/0321135 A1
(43) Pub. Date: Oct. 14, 2021

(54) IMAGE CODING METHOD AND APPARATUS USING TRANSFORM SKIP FLAG

(71) Applicant: LG Electronics Inc., Seoul (KR)

(72) Inventors: Sunmi Yoo, Seoul (KR); Jungah Choi, Seoul (KR); Seunghwan Kim, Seoul (KR); Jin Heo, Seoul (KR); Junghak Nam, Seoul (KR); Jangwon Choi, Seoul (KR)

(21) Appl. No.: 17/357,051

(22) Filed: Jun. 24, 2021

Related U.S. Application Data
(63) Continuation of application No. PCT/KR2020/000064, filed on Jan. 2, 2020.
(60) Provisional application No. 62/787,376, filed on Jan. 1, 2019.

(51) Int. Cl. H04N 19/61; H04N 19/186; H04N 19/176; H04N 19/159

(52) U.S. Cl. CPC H04N 19/61; H04N 19/186; H04N 19/96; H04N 19/159; H04N 19/176

(57) ABSTRACT

An image decoding method according to the present document comprises the steps of: acquiring prediction mode information and residual related information from a bitstream; deriving, on the basis of the prediction mode information, prediction samples of a current block by performing prediction; deriving residual samples of the current block on the basis of the residual related information; and generating restoration samples of the current block on the basis of the prediction samples and the residual samples, and determines whether the residual related information includes a transform skip flag on the basis of whether the current block is a luminance component block or a chrominance component block, wherein the transform skip flag represents whether a transform skip is applied to the current block.

### BACKGROUND OF THE DISCLOSURE

### Field of the Disclosure

The present document relates to an image coding technology, and more particularly, to an image coding method and device using a transform skip flag in an image coding system.

### Related Art

Demand for high-resolution, high-quality images such as HD (High Definition) images and UHD (Ultra High Definition) images has been increasing in various fields. As the image data has high resolution and high quality, the amount of information or bits to be transmitted increases relative to the legacy image data. Therefore, when image data is transmitted using a medium such as a conventional wired/wireless broadband line or image data is stored using an existing storage medium, the transmission cost and the storage cost thereof are increased.

Accordingly, there is a need for a highly efficient image compression technique for effectively transmitting, storing, and reproducing information of high resolution and high quality images.

### SUMMARY OF THE DISCLOSURE

The present document provides a method and a device for enhancing image coding efficiency.

The present document provides a method and a device for enhancing the efficiency of residual coding.

The present document provides a method and a device for enhancing the efficiency of the residual coding according to whether to apply a transform skip.

According to an embodiment of this document, there is provided an image decoding method performed by a decoding apparatus. The method includes obtaining prediction mode information and residual related information from a bitstream, deriving prediction samples of a current block by performing prediction based on the prediction mode information, deriving residual samples of the current block based on the residual related information, and generating reconstructed samples of the current block based on the prediction samples and the residual samples. Whether the residual related information includes a transform skip flag is determined based on whether the current block is a luma component block or a chroma component block. The transform skip flag represents whether a transform skip is applied to the current block.

According to another embodiment of this document, there is provided a decoding apparatus performing image decoding. The decoding apparatus includes an entropy decoder configured to obtain prediction mode information and residual related information from a bitstream, a predictor configured to derive prediction samples of a current block by performing prediction based on the prediction mode information, a residual processor configured to derive residual samples of the current block based on the residual related information, and an adder configured to generate reconstructed samples of the current block based on the prediction samples and the residual samples. Whether the residual related information includes a transform skip flag is determined based on whether the current block is a luma component block or a chroma component block. The transform skip flag represents whether a transform skip is applied to the current block.

According to yet another embodiment of this document, there is provided a video encoding method performed by an encoding apparatus. The method includes deriving prediction samples by performing prediction on a current block, deriving residual samples of the current block, generating reconstructed samples of the current block based on the prediction samples and the residual samples, and encoding image information including prediction mode information related to the prediction and residual related information related to the residual samples. Whether the residual related information includes a transform skip flag is determined based on whether the current block is a luma component block or a chroma component block. The transform skip flag represents whether a transform skip has been applied to the current block.

According to yet another embodiment of this document, there is provided a video encoding apparatus. The encoding apparatus includes a predictor configured to derive prediction samples by performing prediction on a current block, a residual processor configured to derive residual samples of the current block and to generate reconstructed samples of the current block based on the prediction samples and the residual samples, and an entropy encoder configured to encode image information including prediction mode information related to the prediction and residual related information related to the residual samples. Whether the residual related information includes a transform skip flag is determined based on whether the current block is a luma component block or a chroma component block. The transform skip flag represents whether a transform skip has been applied to the current block.

According to yet another embodiment of this document, there is provided a computer-readable digital storage medium. The computer-readable digital storage medium stores a bitstream that causes the decoding method to be performed.

According to yet another embodiment of this document, there is provided a computer-readable digital storage medium. The computer-readable digital storage medium stores a bitstream generated by the encoding method.

According to the present document, it is possible to enhance the overall image/video compaction efficiency.

According to the present document, it is possible to enhance the efficiency of the residual coding by using the transform skip flag.

According to the present document, it is possible to enhance the coding efficiency by efficiently transmitting the residual signal represented by the pixel domain having the characteristics different from those of the residual signal of the general transform domain.

### BRIEF DESCRIPTION OF THE DRAWINGS

FIG. 1 is a diagram schematically illustrating an example of a video/image coding system to which the present document may be applied.

FIG. 2 is a diagram schematically explaining a configuration of a video/image encoding apparatus to which the present document may be applied.

FIG. 3 is a diagram schematically explaining a configuration of a video/image decoding apparatus to which the present document may be applied.

FIG. 4 is a diagram illustrating a block diagram of a CABAC encoding system according to an embodiment.

FIG. 5 is a diagram illustrating an example of transform coefficients within a 4×4 block.

FIG. 6 is a diagram illustrating a residual signal decoder according to an embodiment of this document.

FIG. 7 is a diagram illustrating a transform skip flag parsing determiner according to an embodiment of this document.

FIG. 8 is a flowchart for describing a method of decoding a transform skip flag according to an embodiment of this document.

FIG. 9 is a diagram illustrating a transform skip flag coding unit according to an embodiment of this document.

FIGS. 10 and 11 schematically illustrate examples of a video/image encoding method and related components according to an embodiment(s) of this document.

FIGS. 12 and 13 schematically illustrate examples of a video/image encoding method and related components according to an embodiment(s) of this document.

FIG. 14 schematically illustrates a configuration of a content streaming system.

### DESCRIPTION OF EXEMPLARY EMBODIMENTS

The present document may be modified in various forms, and specific embodiments thereof will be described and illustrated in the drawings. However, the embodiments are not intended for limiting the document. The terms used in the following description are used to merely describe specific embodiments, but are not intended to limit the document. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

Meanwhile, each of the components in the drawings described in this document are shown independently for the convenience of description regarding different characteristic functions, and do not mean that the components are implemented in separate hardware or separate software. For example, two or more of each configuration may be combined to form one configuration, or one configuration may be divided into a plurality of configurations. Embodiments in which each configuration is integrated and/or separated are also included in the scope of this document without departing from the spirit of this document.

Hereinafter, examples of the preferred embodiment of this document will be described in detail with reference to the accompanying drawings. Hereinafter, the same reference numerals are used for the same components in the drawings, and repeated descriptions of the same components may be omitted.

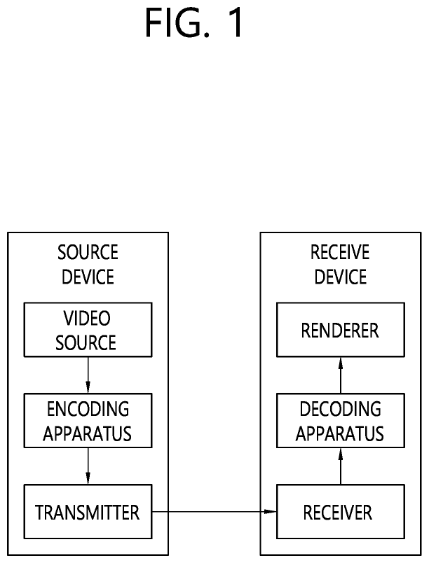

FIG. 1 illustrates an example of a video/image coding system to which the present document may be applied.

Referring to FIG. 1, a video/image coding system may include a source device and a reception device. The source device may transmit encoded video/image information or data to the reception device through a digital storage medium or network in the form of a file or streaming.

The source device may include a video source, an encoding apparatus, and a transmitter. The receiving device may include a receiver, a decoding apparatus, and a renderer. The encoding apparatus may be called a video/image encoding apparatus, and the decoding apparatus may be called a video/image decoding apparatus. The transmitter may be included in the encoding apparatus. The receiver may be included in the decoding apparatus. The renderer may include a display, and the display may be configured as a separate device or an external component.

The video source may acquire video/image through a process of capturing, synthesizing, or generating the video/image. The video source may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding apparatus may encode input video/image. The encoding apparatus may perform a series of procedures such as prediction, transform, and quantization for compaction and coding efficiency. The encoded data (encoded video/image information) may be output in the form of a bitstream.

The transmitter may transmit the encoded image/image information or data output in the form of a bitstream to the receiver of the receiving device through a digital storage medium or a network in the form of a file or streaming. The digital storage medium may include various storage mediums such as USB, SD, CD, DVD, Blu-ray, HDD, SSD, and the like. The transmitter may include an element for generating a media file through a predetermined file format and may include an element for transmission through a broadcast/communication network. The receiver may receive/extract the bitstream and transmit the received bitstream to the decoding apparatus.

The decoding apparatus may decode the video/image by performing a series of procedures such as dequantization, inverse transform, and prediction corresponding to the operation of the encoding apparatus.

The renderer may render the decoded video/image. The rendered video/image may be displayed through the display.

This document relates to video/image coding. For example, a method/embodiment disclosed in this document may be applied to a method disclosed in the versatile video coding (VVC) standard, the essential video coding (EVC) standard, the AOMedia Video 1 (AV1) standard, the 2nd generation of audio video coding standard (AVS2) or the next generation video/image coding standard (e.g., H.267, H.268, or the like).

This document suggests various embodiments of video/image coding, and the above embodiments may also be performed in combination with each other unless otherwise specified.

In this document, a video may refer to a series of images over time. A picture generally refers to the unit representing one image at a particular time frame, and a slice/tile refers to the unit constituting a part of the picture in terms of coding. A slice/tile may include one or more coding tree units (CTUs). One picture may consist of one or more slices/tiles. One picture may consist of one or more tile groups. One tile group may include one or more tiles. A brick may represent a rectangular region of CTU rows within a tile in a picture (a brick may represent a rectangular region of CTU rows within a tile in a picture). A tile may be partitioned into a multiple bricks, each of which may be constructed with one or more CTU rows within the tile (A tile may be partitioned into multiple bricks, each of which consisting of one or more CTU rows within the tile). A tile that is not partitioned into multiple bricks may also be referred to as a brick. A brick scan may represent a specific sequential ordering of CTUs partitioning a picture, wherein the CTUs may be ordered in a CTU raster scan within a brick, and bricks within a tile may be ordered consecutively in a raster scan of the bricks of the tile, and tiles in a picture may be ordered consecutively in a raster scan of the tiles of the picture (A brick scan is a specific sequential ordering of CTUs partitioning a picture in which the CTUs are ordered consecutively in CTU raster scan in a brick, bricks within a tile are ordered consecutively in a raster scan of the bricks of the tile, and tiles in a picture are ordered consecutively in a raster scan of the tiles of the picture). A tile is a particular tile column and a rectangular region of CTUs within a particular tile column (A tile is a rectangular region of CTUs within a particular tile column and a particular tile row in a picture). The tile column is a rectangular region of CTUs, which has a height equal to the height of the picture and a width that may be specified by syntax elements in the picture parameter set (The tile column is a rectangular region of CTUs having a height equal to the height of the picture and a width specified by syntax elements in the picture parameter set). The tile row is a rectangular region of CTUs, which has a width specified by syntax elements in the picture parameter set and a height that may be equal to the height of the picture (The tile row is a rectangular region of CTUs having a height specified by syntax elements in the picture parameter set and a width equal to the width of the picture). A tile scan may represent a specific sequential ordering of CTUs partitioning a picture, and the CTUs may be ordered consecutively in a CTU raster scan in a tile, and tiles in a picture may be ordered consecutively in a raster scan of the tiles of the picture (A tile scan is a specific sequential ordering of CTUs partitioning a picture in which the CTUs are ordered consecutively in CTU raster scan in a tile whereas tiles in a picture are ordered consecutively in a raster scan of the tiles of the picture). A slice may include an integer number of bricks of a picture, and the integer number of bricks may be included in a single NAL unit (A slice includes an integer number of bricks of a picture that may be exclusively contained in a single NAL unit). A slice may be constructed with multiple complete tiles, or may be a consecutive sequence of complete bricks of one tile (A slice may consists of either a number of complete tiles or only a consecutive sequence of complete bricks of one tile). In this document, a tile group and a slice may be used in place of each other. For example, in this document, a tile group/tile group header may be referred to as a slice/slice header.

A pixel or a pel may mean a smallest unit constituting one picture (or image). Also, ‘sample’ may be used as a term corresponding to a pixel. A sample may generally represent a pixel or a value of a pixel, and may represent only a pixel/pixel value of a luma component or only a pixel/pixel value of a chroma component.

A unit may represent a basic unit of image processing. The unit may include at least one of a specific region of the picture and information related to the region. One unit may include one luma block and two chroma (ex. cb, cr) blocks. The unit may be used interchangeably with terms such as block or area in some cases. In a general case, an M×N block may include samples (or sample arrays) or a set (or array) of transform coefficients of M columns and N rows.

In this document, the symbol“/” and “,” should be interpreted as “and/or.” For example, the expression “A/B” is interpreted as “A and/or B”, and the expression “A, B” is interpreted as “A and/or B.” Additionally, the expression “A/B/C” means “at least one of A, B, and/or C.” Further, the expression “A, B, C” also means “at least one of A, B, and/or C.” (In this document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”)

Additionally, in the present document, the term “or” should be interpreted as “and/or.” For example, the expression “A or B” may mean 1) only “A”, 2) only “B”, and/or 3) “both A and B.” In other words, the term “or” in the present document may mean “additionally or alternatively.” (Further, in the document, the term “or” should be interpreted to indicate “and/or.” For instance, the expression “A or B” may comprise 1) only A, 2) only B, and/or 3) both A and B. In other words, the term “or” in this document should be interpreted to indicate “additionally or alternatively.”)

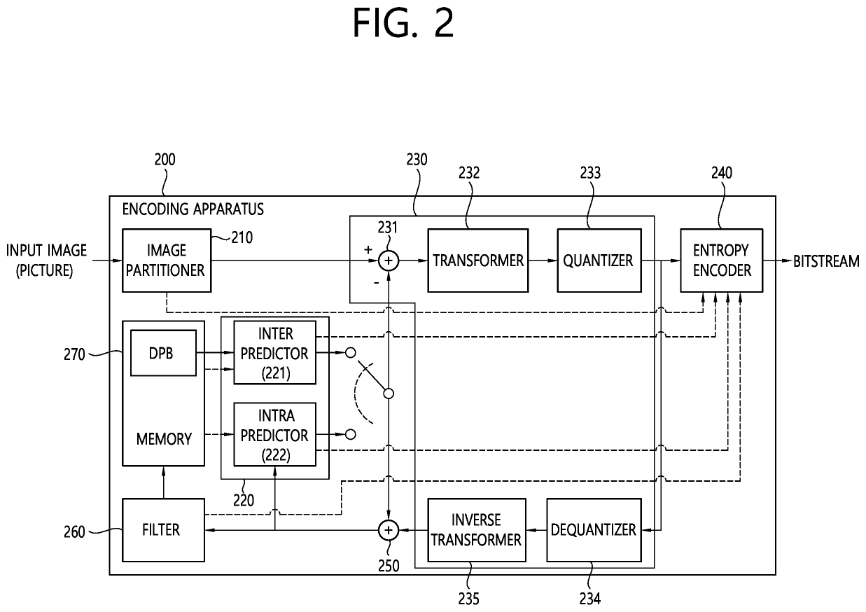

FIG. 2 is a diagram schematically illustrating a configuration of a video/image encoding apparatus to which the present document may be applied. Hereinafter, what is referred to as the video encoding apparatus may include an image encoding apparatus.

Referring to FIG. 2, the encoding apparatus 200 may include and be configured with an image partitioner 210, a predictor 220, a residual processor 230, an entropy encoder 240, an adder 250, a filter 260, and a memory 270. The predictor 220 may include an inter predictor 221 and an intra predictor 222. The residual processor 230 may include a transformer 232, a quantizer 233, a dequantizer 234, and an inverse transformer 235. The residual processor 230 may further include a subtractor 231. The adder 250 may be called a reconstructor or reconstructed block generator. The image partitioner 210, the predictor 220, the residual processor 230, the entropy encoder 240, the adder 250, and the filter 260, which have been described above, may be configured by one or more hardware components (e.g., encoder chipsets or processors) according to an embodiment. In addition, the memory 270 may include a decoded picture buffer (DPB), and may also be configured by a digital storage medium. The hardware component may further include the memory 270 as an internal/external component.

The image partitioner 210 may split an input image (or, picture, frame) input to the encoding apparatus 200 into one or more processing units. As an example, the processing unit may be called a coding unit (CU). In this case, the coding unit may be recursively split according to a Quad-tree binary-tree ternary-tree (QTBTTT) structure from a coding tree unit (CTU) or the largest coding unit (LCU). For example, one coding unit may be split into a plurality of coding units of a deeper depth based on a quad-tree structure, a binary-tree structure, and/or a ternary-tree structure. In this case, for example, the quad-tree structure is first applied and the binary-tree structure and/or the ternary-tree structure may be later applied. Alternatively, the binary-tree structure may also be first applied. A coding procedure according to the present document may be performed based on a final coding unit which is not split any more. In this case, based on coding efficiency according to image characteristics or the like, the maximum coding unit may be directly used as the final coding unit, or as necessary, the coding unit may be recursively split into coding units of a deeper depth, such that a coding unit having an optimal size may be used as the final coding unit. Here, the coding procedure may include a procedure such as prediction, transform, and reconstruction to be described later. As another example, the processing unit may further include a prediction unit (PU) or a transform unit (TU). In this case, each of the prediction unit and the transform unit may be split or partitioned from the aforementioned final coding unit. The prediction unit may be a unit of sample prediction, and the transform unit may be a unit for inducing a transform coefficient and/or a unit for inducing a residual signal from the transform coefficient.

The unit may be interchangeably used with the term such as a block or an area in some cases. Generally, an M×N block may represent samples composed of M columns and N rows or a group of transform coefficients. The sample may generally represent a pixel or a value of the pixel, and may also represent only the pixel/pixel value of a luma component, and also represent only the pixel/pixel value of a chroma component. The sample may be used as the term corresponding to a pixel or a pel configuring one picture (or image).

The encoding apparatus 200 may generate a residual signal (residual block, residual sample array) by subtracting a predicted signal (predicted block, prediction sample array) output from the inter predictor 221 or the intra predictor 222 from the input image signal (original block, original sample array), and the generated residual signal is transmitted to the transformer 232. In this case, as illustrated, the unit for subtracting the predicted signal (predicted block, prediction sample array) from the input image signal (original block, original sample array) within an encoder 200 may be called the subtractor 231. The predictor may perform prediction for a block to be processed (hereinafter, referred to as a current block), and generate a predicted block including prediction samples of the current block. The predictor may determine whether intra prediction is applied or inter prediction is applied in units of the current block or the CU. The predictor may generate various information about prediction, such as prediction mode information, to transfer the generated information to the entropy encoder 240 as described later in the description of each prediction mode. The information about prediction may be encoded by the entropy encoder 240 to be output in a form of the bitstream.

The intra predictor 222 may predict a current block with reference to samples within a current picture. The referenced samples may be located neighboring to the current block, or may also be located away from the current block according to the prediction mode. The prediction modes in the intra prediction may include a plurality of non-directional modes and a plurality of directional modes. The non-directional mode may include, for example, a DC mode or a planar mode. The directional mode may include, for example, 33 directional prediction modes or 65 directional prediction modes according to the fine degree of the prediction direction. However, this is illustrative and the directional prediction modes which are more or less than the above number may be used according to the setting. The intra predictor 222 may also determine the prediction mode applied to the current block using the prediction mode applied to the neighboring block.

The inter predictor 221 may induce a predicted block of the current block based on a reference block (reference sample array) specified by a motion vector on a reference picture. At this time, in order to decrease the amount of motion information transmitted in the inter prediction mode, the motion information may be predicted in units of a block, a sub-block, or a sample based on the correlation of the motion information between the neighboring block and the current block. The motion information may include a motion vector and a reference picture index. The motion information may further include inter prediction direction (L0 prediction, L1 prediction, Bi prediction, or the like) information. In the case of the inter prediction, the neighboring block may include a spatial neighboring block existing within the current picture and a temporal neighboring block existing in the reference picture. The reference picture including the reference block and the reference picture including the temporal neighboring block may also be the same as each other, and may also be different from each other. The temporal neighboring block may be called the name such as a collocated reference block, a collocated CU (colCU), or the like, and the reference picture including the temporal neighboring block may also be called a collocated picture (colPic). For example, the inter predictor 221 may configure a motion information candidate list based on the neighboring blocks, and generate information indicating what candidate is used to derive the motion vector and/or the reference picture index of the current block. The inter prediction may be performed based on various prediction modes, and for example, in the case of a skip mode and a merge mode, the inter predictor 221 may use the motion information of the neighboring block as the motion information of the current block. In the case of the skip mode, the residual signal may not be transmitted unlike the merge mode. A motion vector prediction (MVP) mode may indicate the motion vector of the current block by using the motion vector of the neighboring block as a motion vector predictor, and signaling a motion vector difference.

The predictor 200 may generate a predicted signal based on various prediction methods to be described later. For example, the predictor may not only apply the intra prediction or the inter prediction for predicting one block, but also simultaneously apply the intra prediction and the inter prediction. This may be called a combined inter and intra prediction (CIIP). Further, the predictor may be based on an intra block copy (IBC) prediction mode, or a palette mode in order to perform prediction on a block. The IBC prediction mode or palette mode may be used for content image/video coding of a game or the like, such as screen content coding (SCC). The IBC basically performs prediction in a current picture, but it may be performed similarly to inter prediction in that it derives a reference block in a current picture. That is, the IBC may use at least one of inter prediction techniques described in the present document. The palette mode may be regarded as an example of intra coding or intra prediction. When the palette mode is applied, a sample value in a picture may be signaled based on information on a palette index and a palette table.

The predicted signal generated through the predictor (including the inter predictor 221 and/or the intra predictor 222) may be used to generate a reconstructed signal or used to generate a residual signal. The transformer 232 may generate transform coefficients by applying the transform technique to the residual signal. For example, the transform technique may include at least one of a discrete cosine transform (DCT), a discrete sine transform (DST), a Karhunen-Loève transform (KLT), a graph-based transform (GBT), or a conditionally non-linear transform (CNT). Here, when the relationship information between pixels is illustrated as a graph, the GBT means the transform obtained from the graph. The CNT means the transform which is acquired based on a predicted signal generated by using all previously reconstructed pixels. In addition, the transform process may also be applied to a pixel block having the same size of the square, and may also be applied to the block having a variable size rather than the square.

The quantizer 233 may quantize the transform coefficients to transmit the quantized transform coefficients to the entropy encoder 240, and the entropy encoder 240 may encode the quantized signal (information about the quantized transform coefficients) to the encoded quantized signal to the bitstream. The information about the quantized transform coefficients may be called residual information. The quantizer 233 may rearrange the quantized transform coefficients having a block form in a one-dimensional vector form based on a coefficient scan order, and also generate the information about the quantized transform coefficients based on the quantized transform coefficients of the one dimensional vector form. The entropy encoder 240 may perform various encoding methods, for example, such as an exponential Golomb coding, a context-adaptive variable length coding (CAVLC), and a context-adaptive binary arithmetic coding (CABAC). The entropy encoder 240 may also encode information (e.g., values of syntax elements and the like) necessary for reconstructing video/image other than the quantized transform coefficients together or separately. The encoded information (e.g., encoded video/image information) may be transmitted or stored in units of network abstraction layer (NAL) unit in a form of the bitstream. The video/image information may further include information about various parameter sets such as an adaptation parameter set (APS), a picture parameter set (PPS), a sequence parameter set (SPS), or a video parameter set (VPS). In addition, the video/image information may further include general constraint information. The signaled/transmitted information and/or syntax elements to be described later in this document may be encoded through the aforementioned encoding procedure and thus included in the bitstream. The bitstream may be transmitted through a network, or stored in a digital storage medium. Here, the network may include a broadcasting network and/or a communication network, or the like, and the digital storage medium may include various storage media such as USB, SD, CD, DVD, Blue-ray, HDD, and SSD. A transmitter (not illustrated) for transmitting the signal output from the entropy encoder 240 and/or a storage (not illustrated) for storing the signal may be configured as the internal/external elements of the encoding apparatus 200, or the transmitter may also be included in the entropy encoder 240.

The quantized transform coefficients output from the quantizer 233 may be used to generate a predicted signal. For example, the dequantizer 234 and the inverse transformer 235 apply dequantization and inverse transform to the quantized transform coefficients, such that the residual signal (residual block or residual samples) may be reconstructed. The adder 250 adds the reconstructed residual signal to the predicted signal output from the inter predictor 221 or the intra predictor 222, such that the reconstructed signal (reconstructed picture, reconstructed block, reconstructed sample array) may be generated. As in the case where the skip mode is applied, if there is no residual for the block to be processed, the predicted block may be used as the reconstructed block. The adder 250 may be called a reconstructor or a reconstructed block generator. The generated reconstructed signal may be used for the intra prediction of the next block to be processed within the current picture, and as described later, also used for the inter prediction of the next picture through filtering.

Meanwhile, a luma mapping with chroma scaling (LMCS) may also be applied in a picture encoding and/or reconstruction process.

The filter 260 may apply filtering to the reconstructed signal, thereby improving subjective/objective image qualities. For example, the filter 260 may apply various filtering methods to the reconstructed picture to generate a modified reconstructed picture, and store the modified reconstructed picture in the memory 270, specifically, the DPB of the memory 270. Various filtering methods may include, for example, a deblocking filtering, a sample adaptive offset, an adaptive loop filter, a bilateral filter, and the like. The filter 260 may generate various filtering-related information to transfer the generated information to the entropy encoder 240, as described later in the description of each filtering method. The filtering-related information may be encoded by the entropy encoder 240 to be output in a form of the bitstream.

The modified reconstructed picture transmitted to the memory 270 may be used as the reference picture in the inter predictor 221. If the inter prediction is applied by the inter predictor, the encoding apparatus may avoid the prediction mismatch between the encoding apparatus 200 and the decoding apparatus, and also improve coding efficiency.

The DPB of the memory 270 may store the modified reconstructed picture to be used as the reference picture in the inter predictor 221. The memory 270 may store motion information of the block in which the motion information within the current picture is derived (or encoded) and/or motion information of the blocks within the previously reconstructed picture. The stored motion information may be transferred to the inter predictor 221 to be utilized as motion information of the spatial neighboring block or motion information of the temporal neighboring block. The memory 270 may store the reconstructed samples of the reconstructed blocks within the current picture, and transfer the reconstructed samples to the intra predictor 222.

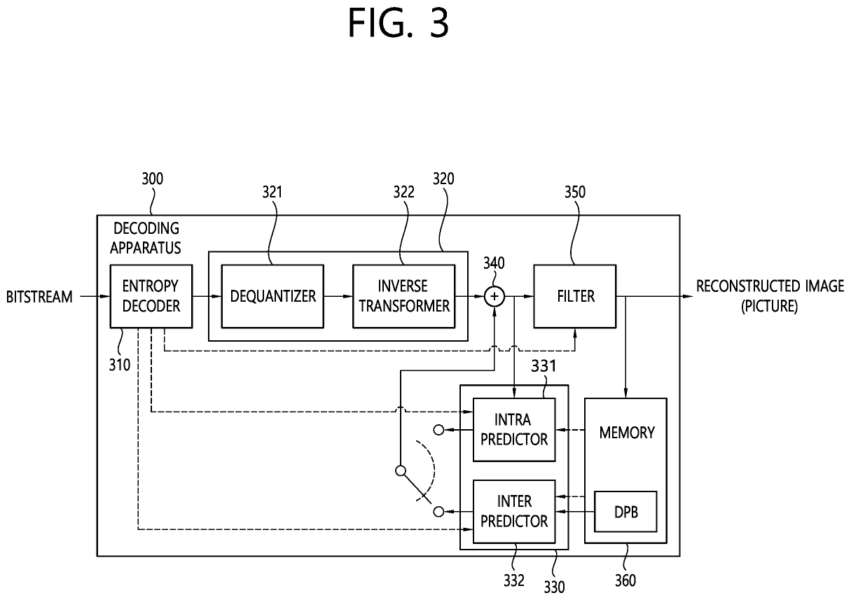

FIG. 3 is a diagram for schematically explaining a configuration of a video/image decoding apparatus to which the present document is applicable.

Referring to FIG. 3, the decoding apparatus 300 may include and configured with an entropy decoder 310, a residual processor 320, a predictor 330, an adder 340, a filter 350, and a memory 360. The predictor 330 may include an inter predictor 331 and an intra predictor 332. The residual processor 320 may include a dequantizer 321 and an inverse transformer 322. The entropy decoder 310, the residual processor 320, the predictor 330, the adder 340, and the filter 350, which have been described above, may be configured by one or more hardware components (e.g., decoder chipsets or processors) according to an embodiment. Further, the memory 360 may include a decoded picture buffer (DPB), and may be configured by a digital storage medium. The hardware component may further include the memory 360 as an internal/external component.

When the bitstream including the video/image information is input, the decoding apparatus 300 may reconstruct the image in response to a process in which the video/image information is processed in the encoding apparatus illustrated in FIG. 2. For example, the decoding apparatus 300 may derive the units/blocks based on block split-related information acquired from the bitstream. The decoding apparatus 300 may perform decoding using the processing unit applied to the encoding apparatus. Therefore, the processing unit for the decoding may be, for example, a coding unit, and the coding unit may be split according to the quad-tree structure, the binary-tree structure, and/or the ternary-tree structure from the coding tree unit or the maximum coding unit. One or more transform units may be derived from the coding unit. In addition, the reconstructed image signal decoded and output through the decoding apparatus 300 may be reproduced through a reproducing apparatus.

The decoding apparatus 300 may receive the signal output from the encoding apparatus illustrated in FIG. 2 in a form of the bitstream, and the received signal may be decoded through the entropy decoder 310. For example, the entropy decoder 310 may derive information (e.g., video/image information) necessary for the image reconstruction (or picture reconstruction) by parsing the bitstream. The video/image information may further include information about various parameter sets such as an adaptation parameter set (APS), a picture parameter set (PPS), a sequence parameter set (SPS), and a video parameter set (VPS). In addition, the video/image information may further include general constraint information. The decoding apparatus may decode the picture further based on the information about the parameter set and/or the general constraint information. The signaled/received information and/or syntax elements to be described later in this document may be decoded through the decoding procedure and acquired from the bitstream. For example, the entropy decoder 310 may decode information within the bitstream based on a coding method such as an exponential Golomb coding, a CAVLC, or a CABAC, and output a value of the syntax element necessary for the image reconstruction, and the quantized values of the residual-related transform coefficient. More specifically, the CABAC entropy decoding method may receive a bin corresponding to each syntax element from the bitstream, determine a context model using syntax element information to be decoded and decoding information of the neighboring block and the block to be decoded or information of the symbol/bin decoded in the previous stage, and generate a symbol corresponding to a value of each syntax element by predicting the probability of generation of the bin according to the determined context model to perform the arithmetic decoding of the bin. At this time, the CABAC entropy decoding method may determine the context model and then update the context model using the information of the decoded symbol/bin for a context model of a next symbol/bin. The information about prediction among the information decoded by the entropy decoder 310 may be provided to the predictor (the inter predictor 332 and the intra predictor 331), and a residual value at which the entropy decoding is performed by the entropy decoder 310, that is, the quantized transform coefficients and the related parameter information may be input to the residual processor 320. The residual processor 320 may derive a residual signal (residual block, residual samples, residual sample array). In addition, the information about filtering among the information decoded by the entropy decoder 310 may be provided to the filter 350. Meanwhile, a receiver (not illustrated) for receiving the signal output from the encoding apparatus may be further configured as the internal/external element of the decoding apparatus 300, or the receiver may also be a component of the entropy decoder 310. Meanwhile, the decoding apparatus according to this document may be called a video/image/picture decoding apparatus, and the decoding apparatus may also be classified into an information decoder (video/image/picture information decoder) and a sample decoder (video/image/picture sample decoder). The information decoder may include the entropy decoder 310, and the sample decoder may include at least one of the dequantizer 321, the inverse transformer 322, the adder 340, the filter 350, the memory 360, the inter predictor 332, and the intra predictor 331.

The dequantizer 321 may dequantize the quantized transform coefficients to output the transform coefficients. The dequantizer 321 may rearrange the quantized transform coefficients in a two-dimensional block form. In this case, the rearrangement may be performed based on a coefficient scan order performed by the encoding apparatus. The dequantizer 321 may perform dequantization for the quantized transform coefficients using a quantization parameter (e.g., quantization step size information), and acquire the transform coefficients.

The inverse transformer 322 inversely transforms the transform coefficients to acquire the residual signal (residual block, residual sample array).

The predictor 330 may perform the prediction of the current block, and generate a predicted block including the prediction samples of the current block. The predictor may determine whether the intra prediction is applied or the inter prediction is applied to the current block based on the information about prediction output from the entropy decoder 310, and determine a specific intra/inter prediction mode.

The predictor may generate the predicted signal based on various prediction methods to be described later. For example, the predictor may not only apply the intra prediction or the inter prediction for the prediction of one block, but also apply the intra prediction and the inter prediction at the same time. This may be called a combined inter and intra prediction (CIIP). Further, the predictor may be based on an intra block copy (IBC) prediction mode, or a palette mode in order to perform prediction on a block. The IBC prediction mode or palette mode may be used for content image/video coding of a game or the like, such as screen content coding (SCC). The IBC basically performs prediction in a current picture, but it may be performed similarly to inter prediction in that it derives a reference block in a current picture. That is, the IBC may use at least one of inter prediction techniques described in the present document. The palette mode may be regarded as an example of intra coding or intra prediction. When the palette mode is applied, information on a palette table and a palette index may be included in the video/image information and signaled.

The intra predictor 331 may predict the current block with reference to the samples within the current picture. The referenced samples may be located neighboring to the current block according to the prediction mode, or may also be located away from the current block. The prediction modes in the intra prediction may include a plurality of non-directional modes and a plurality of directional modes. The intra predictor 331 may also determine the prediction mode applied to the current block using the prediction mode applied to the neighboring block.

The inter predictor 332 may induce the predicted block of the current block based on the reference block (reference sample array) specified by the motion vector on the reference picture. At this time, in order to decrease the amount of the motion information transmitted in the inter prediction mode, the motion information may be predicted in units of a block, a sub-block, or a sample based on the correlation of the motion information between the neighboring block and the current block. The motion information may include a motion vector and a reference picture index. The motion information may further include inter prediction direction (L0 prediction, L1 prediction, Bi prediction, or the like) information. In the case of the inter prediction, the neighboring block may include a spatial neighboring block existing within the current picture and a temporal neighboring block existing in the reference picture. For example, the inter predictor 332 may configure a motion information candidate list based on the neighboring blocks, and derive the motion vector and/or the reference picture index of the current block based on received candidate selection information. The inter prediction may be performed based on various prediction modes, and the information about the prediction may include information indicating the mode of the inter prediction of the current block.

The adder 340 may add the acquired residual signal to the predicted signal (predicted block, prediction sample array) output from the predictor (including the inter predictor 332 and/or the intra predictor 331) to generate the reconstructed signal (reconstructed picture, reconstructed block, reconstructed sample array). As in the case where the skip mode is applied, if there is no residual for the block to be processed, the predicted block may be used as the reconstructed block.

The adder 340 may be called a reconstructor or a reconstructed block generator. The generated reconstructed signal may be used for the intra prediction of a next block to be processed within the current picture, and as described later, may also be output through filtering or may also be used for the inter prediction of a next picture.

Meanwhile, a luma mapping with chroma scaling (LMCS) may also be applied in the picture decoding process.

The filter 350 may apply filtering to the reconstructed signal, thereby improving the subjective/objective image qualities. For example, the filter 350 may apply various filtering methods to the reconstructed picture to generate a modified reconstructed picture, and transmit the modified reconstructed picture to the memory 360, specifically, the DPB of the memory 360. Various filtering methods may include, for example, a deblocking filtering, a sample adaptive offset, an adaptive loop filter, a bidirectional filter, and the like.

The (modified) reconstructed picture stored in the DPB of the memory 360 may be used as the reference picture in the inter predictor 332. The memory 360 may store motion information of the block in which the motion information within the current picture is derived (decoded) and/or motion information of the blocks within the previously reconstructed picture. The stored motion information may be transferred to the inter predictor 260 to be utilized as motion information of the spatial neighboring block or motion information of the temporal neighboring block. The memory 360 may store the reconstructed samples of the reconstructed blocks within the current picture, and transfer the stored reconstructed samples to the intra predictor 331.

In the present specification, the exemplary embodiments described in the filter 260, the inter predictor 221, and the intra predictor 222 of the encoding apparatus 200 may be applied equally to or to correspond to the filter 350, the inter predictor 332, and the intra predictor 331 of the decoding apparatus 300, respectively.

Meanwhile, as described above, in performing video coding, prediction is performed to improve compression efficiency. Through this, a predicted block including prediction samples for a current block as a block to be coded (i.e., a coding target block) may be generated. Here, the predicted block includes prediction samples in a spatial domain (or pixel domain). The predicted block is derived in the same manner in an encoding apparatus and a decoding apparatus, and the encoding apparatus may signal information (residual information) on residual between the original block and the predicted block, rather than an original sample value of an original block, to the decoding apparatus, thereby increasing image coding efficiency. The decoding apparatus may derive a residual block including residual samples based on the residual information, add the residual block and the predicted block to generate reconstructed blocks including reconstructed samples, and generate a reconstructed picture including the reconstructed blocks.

The residual information may be generated through a transform and quantization procedure. For example, the encoding apparatus may derive a residual block between the original block and the predicted block, perform a transform procedure on residual samples (residual sample array) included in the residual block to derive transform coefficients, perform a quantization procedure on the transform coefficients to derive quantized transform coefficients, and signal related residual information to the decoding apparatus (through a bitstream). Here, the residual information may include value information of the quantized transform coefficients, location information, a transform technique, a transform kernel, a quantization parameter, and the like. The decoding apparatus may perform dequantization/inverse transform procedure based on the residual information and derive residual samples (or residual blocks). The decoding apparatus may generate a reconstructed picture based on the predicted block and the residual block. Also, for reference for inter prediction of a picture afterward, the encoding apparatus may also dequantize/inverse-transform the quantized transform coefficients to derive a residual block and generate a reconstructed picture based thereon

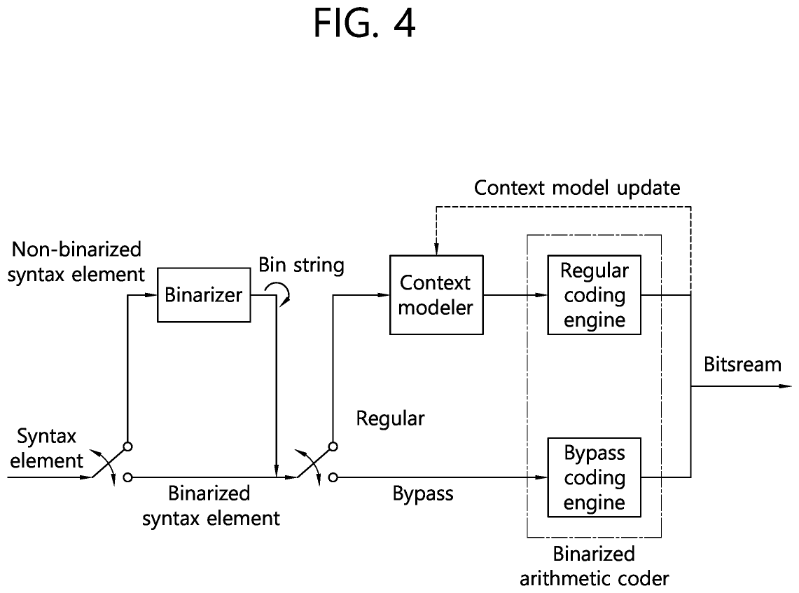

FIG. 4 is a block diagram of a CABAC encoding system according to an embodiment, and illustrates a block diagram of context-adaptive binary arithmetic coding (CABAC) for coding a single syntax element.

The encoding process of the CABAC first transforms an input signal to a binary value through binarization when the input signal is a syntax element rather than a binary value. When the input signal is already a binary value, the input signal may be input by being bypassed without the binarization, that is, to a coding engine. Here, each binary 0 or 1 configuring the binary value may be referred to as a bin. For example, when a binary string after the binarization is 110, each of 1, 1, and 0 is referred to as a bin. The bin (s) for one syntax element may represent a value of the corresponding syntax element.

The binarized bins may be input to a regular coding engine or a bypass coding engine.

The regular coding engine may assign a context model reflecting a probability value to the corresponding bin, and code the corresponding bin based on the assigned context model. The regular coding engine may update the probability model for the corresponding bin after coding each bin. The thus coded bins may be referred to as context-coded bins.

The bypass coding engine omits a procedure of estimating the probability of the input bin and a procedure of updating the probability model applied to the corresponding bin after the coding. By coding the bin which is input by applying the uniform probability distribution rather than assigning the context, it is possible to enhance a coding speed. The thus coded bins are referred to as bypass bins.

Entropy encoding may determine whether to perform the coding through the regular coding engine, or to perform the coding through the bypass coding engine, and switch a coding path. Entropy decoding inversely performs the same process as in the entropy encoding.

Meanwhile, in an embodiment, the (quantized) transform coefficients may be encoded/decoded based on syntax elements, such as transform_skip_flag, last_sig_coeff_x_prefix, last_sig_coeff_y_prefix, last_sig_coeff_x_suffix, last_sig_coeff_y_suffix, coded_sub_block_flag, sig_coeff_flag, abs_level_gt1_flag, par_level_flag, abs_level_gt3_flag, abs remainder, dec_abs_level, coeff_sign_flag and/or mts_idx.

For example, the residual related information or the syntax elements included in the residual related information may be represented as in Tables 1 to 6. Alternatively, the residual coding information included in the residual related information or the syntax elements included in the residual coding syntax may be represented as in Tables 1 to 6. Tables 1 to 6 may represent one syntax consecutively.

TABLE 1

| residual_coding( x0, y0, log2TbWidth, log2TbHeight, cIdx ) { | Descriptor |
|---|---|
| if( transform_skip_enabled_flag && | |
| ( cIdx ! = 0 \| \| cu_mts_flag[ x0 ][ y0 ] = = 0 ) && | |
| ( log2TbWidth <= 2 ) && ( log2TbHeight <= 2 ) ) | |
| transform_skip_flag[ x0 ][ y0 ][ cIdx ] | ae(v) |
| last_sig_coeff_x_prefix | ae(v) |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |

TABLE 2

| | |
|---|---|
| log2SbSize = ( Min( log2TbWidth, log2TbHeight ) < 2 ? 1 : 2 ) | |
| numSbCoeff = 1 << ( log2SbSize << 1 ) | |
| lastScanPos = numSbCoeff | |
| lastSubBlock = ( 1 << ( log2TbWidth + log2TbHeight − 2 * log2SbSize ) ) − 1 | |
| do { | |
| if( lastScanPos = = 0 ) { | |
| lastScanPos = numSbCoeff | |
| lastSubBlock− − | |
| } | |
| lastScanPos− − | |
| xS = | |
| DiagScanOrder[ log2TbWidth − log2SbSize ][ log2TbHeight − log2SbSize ] | |
| [ lastSubBlock ][ 0 ] | |
| yS = | |
| DiagScanOrder[ log2TbWidth − log2SbSize ][ log2TbHeight − log2SbSize ] | |
| [ lastSubBlock ][ 1 ] | |
| xC = ( xS << log2SbSize ) + | |
| DiagScanOrder[ log2SbSize ][ log2SbSize ][ lastScanPos ][ 0 ] | |
| yC = ( yS << log2SbSize ) + | |
| DiagScanOrder[ log2SbSize ][ log2SbSize ][ lastScanPos ][ 1 ] | |
| } while( ( xC != LastSignificantCoeffX ) \| \| ( yC != LastSignificantCoeffY ) ) | |
| numSigCoeff = 0 | |
| QState = 0 | |
| for( i = lastSubBlock; i >= 0; i− − ) { | |
| startQStateSb = QState | |
| xS = | |
| DiagScanOrder[ log2TbWidth − log2SbSize ][ log2TbHeight − log2SbSize ] | |
| [ lastSubBlock ][ 0 ] | |
| yS = | |
| DiagScanOrder[ log2TbWidth − log2SbSize ][ log2TbHeight − log2SbSize ] | |
| [ lastSubBlock ][ 1 ] | |
| inferSbDcSigCoeffFlag = 0 | |
| if( ( i < lastSubBlock ) && ( i > 0 ) ) { | |
| coded_sub_block_flag[ xS ][ yS ] | ae(v) |
| inferSbDcSigCoeffFlag = 1 | |

TABLE 3

| | |
|---|---|
| } | |
| firstSigScanPosSb = numSbCoeff | |
| lastSigScanPosSb = −1 | |
| remBinsPass1 = ( log2SbSize < 2 ? 6 : 28) | |
| remBinsPass2 = ( log2SbSize < 2 ? 2 : 4) | |
| firstPosMode0 = ( i = = lastSubBlock ? lastScanPos − 1 : numSbCoeff − 1 ) | |
| firstPosMode1 = −1 | |
| firstPosMode2 = −1 | |
| for( n = ( i = = firstPosMode0; n >= 0 && remBinsPass1 >= 3; n− −) | |
| { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( coded_sub_block_flag[ xS ][ yS ] && (n > 0 | |
| \| \| !inferSbDcSigCoeffFlag ) ) { | |
| sig_coeff_flag[ xC ][ yC ] | ae(v) |
| remBinsPass1− − | |
| if( sig_coeff_flag[ xC ][ yC ] ) | |
| inferSbDcSigCoeffFlag = 0 | |
| } | |
| if( sig_coeff_flag[ xC ][ yC ] ) { | |
| numSigCoeff+ + | |
| abs_level_gt1_flag[ n ] | ae(v) |
| remBinsPass1− − | |
| if( abs_level_gt1_flag[ n ] ) { | |
| par_level_flag[ n ] | ae(v) |
| remBinsPass1− − | |
| if( remBinsPass2 > 0 ) { | |
| remBinsPass2− − | |
| if( remBinsPass2 = = 0 ) | |
| firstPosMode1 = n − 1 | |
| } | |
| { | |

TABLE 4

| | |
|---|---|
| if( lastSigScanPosSb = = −1 ) | |
| lastSigScanPosSb = n | |
| firstSigScanPosSb = n | |
| } | |
| AbsLevelPass1[ xC ][ yC ] = | |
| sig_coeff_flag[ xC ][ yC ] + par_level_flag[ n ] + abs_level_gt1_flag[ n ] | |
| if( dep_quant_enabled_flag ) | |
| QState = QStateTransTable[ QState ][ AbsLevelPass1[ xC ][ yC ] & 1 ] | |
| if( remBinsPass1 < 3 ) | |
| firstPosMode2 = n − 1 | |
| } | ae(v) |
| if( firstPosMode1 < firstPosMode2 ) | |
| firstPosMode1 = firstPosMode2 | |
| for( n = numSbCoeff − 1; n >= firstPosMode2; n− − ) | |
| if( abs_level_gt1_flag[ n ] ) | |
| abs_level_gt3_flag[ n ] | ae(v) |
| for( n = numSbCoeff − 1; n >= firstPosMode1; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( abs_level_gt3_flag[ n ] ) | |
| abs_remainder[ n ] | ae(v) |
| AbsLevel[ xC ][ yC ] = AbsLevelPass1[ xC ][ yC ] + | |
| 2 * ( abs_level_gt3_flag[ n ] + abs_remainder[ n ] ) | |
| } | |
| for( n = firstPosMode1; n > firstPosMode2; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( abs_level_gt1_flag[ n ] ) | |
| abs_remainder[ n ] | ae(v) |
| AbsLevel[ xC ][ yC ] = AbsLevelPass1[ xC ][ yC ] + 2 * abs_remainder[ n ] | |

TABLE 5

| | |
|---|---|
| } | |
| for( n = firstPosMode2; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| dec_abs_level[ n ] | ae(v) |
| if(AbsLevel[ xC ][ yC ] > 0 ) | |
| firstSigScanPosSb = n | |
| if( dep_quant_enabled_flag ) | |
| QState = QStateTransTable[ QState ][ AbsLevel[ xC ][ yC ] & 1 ] | |
| } | |
| if( dep_quant_enabled_flag \| \| !sign_data_hiding_enabled_flag ) | |
| signHidden = 0 | |
| else | |
| signHidden = ( lastSigScanPosSb − firstSigScanPosSb > 3 ? 1 : 0 ) | |
| for( n = numSbCoeff − 1; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( sig_coeff_flag[ xC ][ yC ] && | |
| ( !signHidden \| \| ( n != firstSigScanPosSb ) ) ) | |
| coeff_sign_flag[ n ] | ae(v) |
| } | |
| if( dep_quant_enabled_flag ) { | |
| QState = startQStateSb | |
| for( n = numSbCoeff − 1; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( sig_coeff_flag[ xC ][ yC ] ) | |

TABLE 6

| | |
|---|---|
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QStateTransTable[ QState ][ par_level_flag[ n ] ] | |
| } else { | |
| sumAbsLevel = 0 | |
| for( n = numSbCoeff − 1; n >= 0; n− − ) { | |
| xC = ( xS << log2SbSize ) + | |
| DiagScanOrder[ log2SbSize ][ log2SbSize ][ n ][ 0 ] | |
| yC = ( yS << log2SbSize ) + | |
| DiagScanOrder[ log2SbSize ][ log2SbSize ][ n ][ 1 ] | |
| if( sig_coeff_flag[ xC ][ yC ] ) { | |
| TransCoeffLevel[ x0 ][ y0 ][ cIdx ][ xC ][ yC ] = | |
| AbsLevel[ xC ][ yC ] * ( 1 − 2 * coeff_sign_flag[ n ] ) | |
| if( signHidden ) { | |
| sumAbsLevel += AbsLevel[ xC ][ yC ] | |
| if( ( n = = firstSigScanPosSb ) && ( sumAbsLevel % 2 ) = = | |
| 1 ) ) | |
| TransCoeffLevel[ x0 ][ y0 ][ cIdx ][ xC ][ yC ] = | |
| −TransCoeffLevel[ x0 ][ y0 ][ cIdx ][ xC ][ yC ] | |
| } | |
| } | |
| } | |
| } | |
| } | |
| if( tu_mts_flag[ x0 ][ y0 ] && ( cIdx = = 0 ) ) | |
| mts_idx[ x0 ][y0 ][ cIdx ] | ae(v) |
| } | |

For example, the residual related information may include the residual coding information (or syntax elements included in the residual coding syntax) or the transform unit information (or syntax elements included in the transform unit syntax), the residual coding information may be represented as in Tables 7 to 10, and the transform unit information may be represented as in Table 11 or Table 12. Tables 7 to 10 may represent one syntax consecutively.

TABLE 7

| residual_coding( x0, y0, log2TbWidth, log2TbHeight, cIdx ) { | Descriptor |
|---|---|
| if( sps_mts_enabled_flag && cu_sbt_flag && cIdx = = 0 && | |
| log2TbWidth = = 5 && log2TbHeight < 6 ) | |
| log2ZoTbWidth = 4 | |
| else | |
| log2ZoTbWidth = Min( log2TbWidth, 5 ) | |
| if( sps_mts_enabled_flag && cu_sbt_flag && cIdx = = 0 && | |
| log2TbWidth < 6 && log2TbHeight = = 5 ) | |
| log2ZoTbHeight = 4 | |
| else | |
| log2ZoTbHeight = Min( log2TbHeight, 5 ) | |
| if( log2TbWidth > 0 ) | |
| last_sig_coeff_x_prefix | ae(v) |
| if( log2TbHeight > 0 ) | |
| last_sig_coeff_y_prefix | ae(v) |
| if( last_sig_coeff_x_prefix > 3 ) | |
| last_sig_coeff_x_suffix | ae(v) |
| if( last_sig_coeff_y_prefix > 3 ) | |
| last_sig_coeff_y_suffix | ae(v) |
| log2TbWidth = log2ZoTbWidth | |
| log2TbHeight = log2ZoTbHeight | |
| remBinsPass1 = ( ( 1 << ( log2TbWidth + log2TbHeight ) ) * 7 ) >> 2 | |
| log2SbW = ( Min( log2TbWidth, log2TbHeight ) < 2 ? 1 : 2 ) | |
| log2SbH = log2SbW | |
| if( log2TbWidth − log2TbHeight > 3 ) { | |
| if( log2TbWidth < 2 ) { | |
| log2SbW = log2TbWidth | |
| log2SbH = 4 − log2SbW | |
| } else if( log2TbHeight < 2 ) { | |
| log2SbH = log2TbHeight | |
| log2SbW = 4 − log2SbH | |
| } | |
| } | |
| numSbCoeff = 1 << ( log2SbW + log2SbH ) | |
| lastScanPos = numSbCoeff | |
| lastSubBlock = ( 1 << ( log2TbWidth − log2TbHeight − ( log2SbW + log2SbH ) ) ) − 1 | |
| do { | |
| if( lastScanPos = = 0 ) { | |
| lastScanPos = numSbCoeff | |
| lastSubBlock− − | |
| } | |
| lastScanPos− − | |
| xS = DiagScanOrder[ log2TbWidth − log2SbW ][ log2TbHeight − log2SbH ] | |
| [ lastSubBlock ][ 0 ] | |
| yS = DiagScanOrder[ log2TbWidth − log2SbW ][ log2TbHeight − log2SbH ] | |
| [ lastSubBlock ][ 1 ] | |
| xC = ( xS << log2SbW ) + DiagScanOrder[ log2SbW ][ log2SbH ][ lastScanPos ][ 0 ] | |

TABLE 8

| | |
|---|---|
| yC = ( yS << log2SbH ) + DiagScanOrder[ log2SbW ][ log2SbH ][ lastScanPos ][ 1 ] | |
| } while( ( xC != LastSignificantCoeffX ) \| ( yC != LastSignificantCoeffY ) ) | |
| if( lastSubBlock = = 0 && log2TbWidth >= 2 && log2TbHeight >= 2 && | |
| !transform_skip_flag[ x0 ][ y0 ][ cIdx ] && lastScanPos > 0 ) | |
| LfnstDcOnly = 0 | |
| if( ( lastSubBlock > 0 && log2TbWidth >= 2 && log2TbHeight >= 2 ) \| \| | |
| ( lastScanPos > 7 && ( log2TbWidth = = 2 \| \| log2TbWidth = = 3 ) && | |
| log2TbWidth = = log2TbHeight ) ) | |
| LfnstZeroOutSigCoeffFlag = 0 | |
| if( ( LastSignificantCoeffX > 15 \| \| LastSignificantCoeffY > 15 ) && cIdx = = 0 ) | |
| MtsZeroOutSigCoeffFlag = 0 | |
| QState = 0 | |
| for( i = lastSubBlock; i >= 0; i− − ) { | |
| startQStateSb = QState | |
| xS = DiagScanOrder[ log2TbWidth − log2SbW ][ log2TbHeight − log2SbH ] | |
| [ i ][ 0 ] | |
| yS = DiagScanOrder[ log2TbWidth − log2SbW ][ log2TbHeight − log2SbH ] | |
| [ i ][ 1 ] | |
| inferSbDcSigCoeffFlag = 0 | |
| if( i < lastSubBlock && i > 0 ) { | |
| coded_sub_block_flag[ xS ][ yS ] | ae(v) |
| inferSbDeSigCoeffFlag = 1 | |
| } | |
| firstSigScanPosSb = numSbCoeff | |
| lastSigScanPosSb = −1 | |
| firstPosMode0 = ( i = = lastSubBlock ? lastScanPos : numSbCoeff − 1 ) | |
| firstPosMode1 = firstPosMode0 | |
| for( n = firstPosMode0; n >= 0 && remBinsPass1 >= 4; n− − ) { | |
| xC = ( xS << log2SbW ) − DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( coded_sub_block_flag[ xS ][ yS ] && ( n > 0 \| \| !inferSbDeSigCoeffFlag ) && | |
| ( xC != LastSignificantCoeffX \| \| yC != Last SignificantCoeffY ) ) { | |
| sig_coeff_flag[ xC ][ yC ] | ae(v) |
| remBinsPass1− − | |
| if( sig_coeff_flag[ xC ][ yC ] ) | |
| inferSbDeSigCoeffFlag = 0 | |
| } | |
| if( sig_coeff_flag[ xC ][ yC ] ) { | |
| abs_level_gtx_flag[ n ][ 0 ] | ae(v) |
| remBinsPass1− − | |
| if( abs_level_gtx_flag[ n ][ 0 ] ) { | |
| par_level_flag[ n ] | ae(v) |
| remBinsPass1− − | |
| abs_level_gtx_flag[ n ][ 1 ] | ae(v) |
| remBinsPass1− − | |
| } | |
| if( lastSigScanPosSb = = −1 ) | |
| lastSigScanPosSb = n | |
| firstSigScanPosSb = n | |
| } | |

TABLE 9

| | |
|---|---|
| AbsLevelPass1[ xC ][ yC ] = sig_coeff_flag[ xC ][ yC ] − par_level_flag[ n ] − | |
| abs_level_gtx_flag[ n ][ 0 ] − 2 * abs_level_gtx_flag[ n ][ 1 ] | |
| if( pic_dep_quant_enabled_flag ) | |
| QState = QStateTransTable[ QState ][ AbsLevelPass1[ xC ][ yC ] & 1 ] | |
| firstPosMode1 = n − 1 | |
| } | |
| for( n = firstPosMode0; n > firstPosMode1; n− − ) { | |
| xC = ( xS << log2SbW ) + DiagScanOrder[ log2SbW ][ log2SbH ][ n ][ 0 ] | |
| yC = ( yS << log2SbH ) − DiagScanOrder[ log2SbW ][ log2SbH ][ n ][ 1 ] | |
| if( abs_level_gtx_flag[ n ][ 1 ] ) | |
| abs_remainder[ n ] | ae(v) |
| AbsLevel[ xC ][ yC ] = AbsLevelPass1[ xC ][ yC ] −2 * abs_remainder[ n ] | |
| } | |
| for( n = firstPosMode1; n >= 0; n− − ) { | |
| xC = ( xS << log2SbW ) + DiagScanOrder[ log2SbW ][ log2SbH ][ n ][ 0 ] | |
| yC = ( yS << log2SbH ) − DiagScanOrder[ log2SbW ][ log2SbH ][ n ][ 1 ] | |
| if( coded_sub_block_flag[ xS ][ yS ] ) | |
| dec_abs_level[ n ] | ae(v) |
| if( AbsLevel[ xC ][ yC ] > 0 ) { | |
| if( lastSigScanPosSb = = −1 ) | |
| lastSigScanPosSb = n | |
| firstSigScanPosSb = n | |
| } | |
| if(pic_dep_quant_enabled_flag ) | |
| QState = QStateTransTable[ QState ][ AbsLevel[ xC ][ yC ] & 1 ] | |
| } | |
| if( pic_dep_quant_enabled_flag \| \| !sign_data_hiding_enabled_flag ) | |
| signHidden = 0 | |
| else | |
| signHidden = ( lastSigScanPosSb − firstSigScanPosSb > 3 ? 1 : 0 ) | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) − DiagScanOrder[ log2SbW ][ log2SbH ][ n ][ 1 ] | |
| if( ( AbsLevel[ xC ][ yC ] > 0 ) && | |
| ( !signHidden \| \| ( n != firstSigScanPosSb ) ) ) | |
| coeff_sign_flag[ n ] | ae(v) |
| } | |
| if( pic_dep_quant_enabled_flag ) { | |
| QState = startQStateSb | |
| for( n = numSbCoeff − 1; n >= 0; n− − ) { | |
| xC = ( xS << log2SbW ) + DiagScanOrder[ log2SbW ][ log2SbH ][ n ][ 0 ] | |
| yC = ( yS << log2SbH ) + DiagScanOrder[ log2SbW ][ log2SbH ][ n ][ 1 ] | |
| if( AbsLevel[ xC ][ yC ] > 0 ) | |
| TransCoeffLevel[ x0 ][ y0 ][ cIdx ][ xC ][ yC ] = | |
| ( 2 * AbsLevel[ xC ][ yC ] − ( QState > 1 ? 1 : 0 ) ) * | |
| ( 1 − 2 * coeff_sign_flag[ n ] ) | |
| QState = QStateTransTable[ QState ][ AbsLevel[ xC ][ yC ] & 1 ] | |
| } else { | |
| sumAbsLevel = 0 | |

```
TABLE 10
    for( n = numSbCoeff − 1; n >= 0; n− − ) {
      xC = ( xS << log2SbW ) + DiagScanOrder[ log2SbW ][ log2SbH ][ n ][ 0 ]
      yC = (yS << log2SbH ) + DiagScanOrder[ log2SbW ][ log2SbH ][ n ][ 1 ]
      if( AbsLevel[ xC ][ yC ] > 0 ) {
        TransCoeffLevel[ x0 ][ y0 ][ cIdx ][ xC ][ yC ] =
            AbsLevel[ xC ][ yC ] * ( 1 − 2 * coeff_sign_flag[ n ] )
        if( signHidden ) {
          sumAbsLevel += AbsLevel[ xC ][ yC ]
          if( ( n = = firstSigScanPosSb ) && ( sumAbsLevel % 2 ) = = 1 ) )
            TransCoeffLevel[ x0 ][ y0 ][ cIdx ][ xC ][ yC ] =
              −TransCoeffLevel[ x0 ][ y0 ][ cIdx ][ xC ][ yC ]
        }
      }
    }
  }
}
```

TABLE 11

| transform_unit( x0, y0, tbWidth, tbHeight, treeType, subTuIndex ) { | Descriptor |
|---|---|
| if( ( treeType = = SINGLE_TREE \| \| treeType = = DUAL_TREE_CHROMA ) && | |
| ChromaArrayType != 0 ) { | |
| if( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) ) \| \| | |
| ( IntraSubPartitionsSplitType != ISP_NO_SPLIT && | |
| ( subTuIndex = = NumIntraSubPartitions − 1 ) ) ) { | |
| tu_cbf_cb[ x0 ][ y0 ] | ae(v) |
| tu_cbf_cr[ x0 ][ y0 ] | ae(v) |
| } | |
| } | |
| if( treeType = = SINGLE_TREE \| \| treeType = = DUAL_TREE_LUMA ) { | |
| if( ( IntraSubPartitionsSplitType = = ISP_NO_SPLIT && !( cu_sbt_flag && | |
| ( ( subTuIndex = = 0 && cu_sbt_pos_flag ) \| \| | |
| ( subTuIndex = = 1 && !cu_sbt_pos_flag ) ) ) && | |
| ( CuPredMode[ x0 ][ y0 ] = = MODE_INTRA \| \| | |
| tu_cbf_cb[ x0 ][ y0 ] \| \| tu_cbf_cr[ x0 ][ y0 ] \| \| | |
| CbWidth[ x0 ][ y0 ] > MaxTbSizeY \| \| CbHeight[ x0 ][ y0 ] > MaxTbSizeY ) ) \| \| | |
| ( IntraSubPartitionsSplitType != ISP_NO_SPLIT && | |
| ( subTuIndex < NumIntraSubPartitions − 1 \| \| !InferTuCbfLuma ) ) ) | |
| tu_cbf_luma[ x0 ][ y0 ] | ae(v) |
| if (IntraSubPartitionsSplitType != ISP_NO_SPLIT ) | |
| InferTuCbfLuma = InferTuCbfLuma && !tu_cbf_luma[ x0 ][ y0 ] | |
| } | |
| . . . | |
| if( ( tu_cbf_luma[ x0 ][ y0 ] \| \| tu_cbf_cb[ x0 ][ y0 ] \| \| tu_cbf_cr[ x0 ][ y0 ] ) && | |
| treeType != DUAL_TREE_CHROMA ) { | |
| if( cu_qp_delta_enabled_flag && !IsCuQpDeltaCoded ) { | |
| cu_qp_delta_abs | ae(v) |
| if( cu_qp_delta_abs ) | |
| cu_qp_delta_sign_flag | ae(v) |
| } | |
| } | |
| if( tu_cbf_luma[ x0 ][ y0 ] && treeType != DUAL_TREE_CHROMA | |
| && ( tbWidth <= 32 ) && ( tbHeight <= 32 ) | |
| && ( IntraSubPartitionsSplit[ x0 ][ y0 ] = = ISP_NO_SPLIT ) && ( !cu_sbt_flag ) ) { | |
| if( transform_skip_enabled_flag && tbWidth <= MaxTsSize && tbHeight <= MaxTsSize ) | |
| transform_skip_flag[ x0 ][ y0 ] | ae(v) |
| if( (( CuPredMode[ x0 ][ y0 ] != MODE_INTRA && sps_explicit_mts_inter_enabled_flag ) | |
| \| \| ( CuPredMode[ x0 ][ y0 ] = = MODE_INTRA && sps_explicit_mts_intra_enabled_flag )) | |
| && ( !transform_skip_flag[ x0 ][ y0 ] ) ) | |
| tu_mts_idx[ x0 ][ y0 ] | ae(v) |
| . . . | |

TABLE 12

| transform_unit( x0, y0, tbWidth, tbHeight, treeType, subTuIndex, chType ) { | Descriptor |
|---|---|
| . . . | |
| if( tu_cbf_luma[ x0 ][ y0 ] && treeType != DUAL_TREE_CHROMA ) { | |
| if( sps_transform_skip_enabled_flag && !BdpcmFlag[ x0 ][ y0 ][ 0 ] && | |
| tbWidth <= MaxTsSize && tbHeight <= MaxTsSize && | |
| ( IntraSubPartitionsSplit[ x0 ][ y0 ] = = ISP_NO_SPLIT ) && !cu_sbt_flag ) | |
| transform_skip_flag[ x0 ][ y0 ][ 0 ] | ae(v) |
| if( !transform_skip_flag[ x0 ][ y0 ][ 0 ] ) | |
| residual_coding( x0, y0, Log2( tbWidth ), Log2( tbHeight ), 0 ) | |
| else | |
| residual_ts_coding( x0, y0, Log2( tbWidth ), Log2( tbHeight ), 0 ) | |
| } | |
| if( tu_cbf_cb[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ) | |
| transform_skip_flag[ xC ][ yC ][ 1 ] | ae(v) |
| if( !transform_skip_flag[ xC ][ yC ][ 1 ] ) | |
| residual_coding( xC, yC, Log2( wC ), Log2( hC ), 1 ) | |
| else | |
| residual_ts_coding( xC, yC, Log2( wC ), Log2( hC ), 1 ) | |
| } | |
| if( tu_cbf_cr[ xC ][ yC ] && treeType != DUAL_TREE_LUMA && | |
| !( tu_cbf_cb[ xC ][ yC ] && tu_joint_cbcr_residual_flag[ xC ][ yC ] ) ) { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| if( !transform_skip_flag[ xC ][ yC ][ 2 ] ) | |
| residual_coding( xC, yC, Log2( wC ), Log2( hC ), 2 ) | |
| else | |
| residual_ts_coding( xC, yC, Log2 ( wC ), Log2( hC ), 2 ) | |
| } | |
| } | |

The syntax element transform_skip_flag represents whether the transform for an associated block is omitted. The associated block may be a coding block (CB) or a transform block (TB). With regard to the transform (and quantization) and residual coding procedures, the CB and TB may be used interchangeably. For example, as described above, the residual samples with respect to the CB may be derived, and the (quantized) transform coefficients may be derived through the transform and the quantization for the residual samples, and information (for example, syntax elements) efficiently representing the position, size, sign, and the like of the (quantized) transform coefficients may be generated and signaled through the residual coding procedure. The quantized transform coefficients may be simply referred to as transform coefficients. Generally, when the CB is not greater than the maximum TB, the size of the CB may be equal to the size of the TB, and in this case, a target block to be transformed (and quantized) and residual coded may be referred to as CB or TB. Meanwhile, when the CB is greater than the maximum TB, the target block to be transformed (and quantized) and residual coded may be referred to as TB. Hereinafter, while it will be described that the syntax elements related to the residual coding are signaled in units of transform block (TB), this is illustrative and the TB may be used interchangeably with the coding block (CB) as described above.

In Tables 1 to 6, while it has been illustrated that the syntax element transform_skip_flag is signaled based on the residual coding syntax, this is illustrative, and the syntax element transform_skip_flag may also be signaled based on the transform unit syntax as illustrated in Table 11 or Table 12. The residual coding syntax and the transform unit syntax may be collectively referred to as the residual (related) information. For example, the syntax element transform_skip_flag may be signaled only for the luma component (luma component block) (see Table 11). Specifically, for example, when a non-zero significant coefficient exists in the luma component block, the residual related information may include the transform skip flag (transform_skip_flag) for the luma component block. In this case, the residual related information does not include the transform skip flag for the chroma component block. That is, the residual related information may include the transform skip flag for the luma component block, and may not include the transform skip flag for the chroma component block. That is, in this case, the transform skip flag for the chroma component block is not explicitly signaled, and the value of the transform skip flag for the chroma component block may be derived/inferred to 0.

Alternatively, as another example, the syntax element transform_skip_flag may also be signaled for the luma component (luma component block) and the chroma component (chroma component block), respectively (see Table 12).

Referring back to Tables 1 to 6 or Tables 7 to 10, an embodiment may code (x, y) position information of the last non-zero transform coefficient within the transform block based on the syntax elements last_sig_coeff_x_prefix, last_sig_coeff_y_prefix, last_sig_coeff_x_suffix, and last_sig_coeff_y_suffix. More specifically, the syntax element last_sig_coeff_x_prefix represents the prefix of the column position of the last significant coefficient in the scanning order within the transform block, the syntax element last_sig_coeff_y_prefix represents the prefix of the row position of the last significant coefficient in the scanning order within the transform block, the syntax element last_sig_coeff_x_suffix represents the suffix of the column position of the last significant coefficient in the scanning order within the transform block, and the syntax element last_sig_coeff_y_suffix represents the suffix of the row position of the last significant coefficient in the scanning order within the transform block. Here, the significant coefficient may represent the non-zero coefficient. The scanning order may be an up-right diagonal scanning order. Alternatively, the scanning order may be a horizontal scanning order or a vertical scanning order. The scanning order may be determined based on whether the intra/inter prediction is applied to the target block (CB, or CB including TB) and/or a specific intra/inter prediction mode.

Next, after the transform block is split into 4×4 sub-blocks, whether the non-zero coefficient exists within a current sub-block by using a 1-bit syntax element coded_sub_block_flag every 4×4 sub-block. The sub-block may be used interchangeably with a Coefficient Group (CG).

When a value of the syntax element coded_sub_block_flag is 0, there is no more information to be transmitted, such that the coding process for the current sub-block may be terminated. Conversely, when the value of the syntax element coded_sub_block_flag is 1, the coding process for the syntax element sig_coeff_flag may be continuously performed. Since the sub-block including the last non-zero coefficient does not require the coding for the syntax element coded_sub_block_flag, and the sub-block including DC information of the transform block has a high probability of including the non-zero coefficient, the value of the syntax element coded_sub_block_flag may be assumed to be 1 without being coded.

If the value of the syntax element coded_sub_block_flag is 1 and it is determined that the non-zero coefficient exists within the current sub-block, the syntax element sig_coeff_flag having a binary value may be coded according to the inversely scanned order. A 1-bit syntax element sig_coeff_flag may be coded for each coefficient according to the scanning order. If the value of the transform coefficient at the current scanning position is not 0, the value of the syntax element sig_coeff_flag may be 1. Here, in the case of the sub-block including the last non-zero coefficient, the coding process for the sub-block may be omitted because it is not necessary to code the syntax element sig_coeff_flag with respect to the last non-zero coefficient. Level information coding may be performed only when the syntax element sig_coeff_flag is 1, and four syntax elements may be used in the level information coding process. More specifically, each syntax element sig_coeff_flag [xC] [yC] may represent whether the level (value) of the corresponding transform coefficient at each transform coefficient position (xC, yC) within the current TB is non-zero. In an embodiment, the syntax element sig_coeff_flag may correspond to an example of a significant coefficient flag representing whether the quantized transform coefficient is a non-zero significant coefficient.

The remaining level value after the coding for the syntax element sig_coeff_flag may be as is expressed in Equation 1 below. That is, a syntax element remAbsLevel representing the level value to be coded may be as is expressed in Equation 1 below. Here, coeff may mean an actual transform coefficient value.

remAbsLevel=|coeff|−1 [Equation 1]

The syntax element abs_level_gt1_flag may represent whether the remAbsLevel′ at the corresponding scanning position (n) is greater than 1. When a value of the abs_level_gt1_flag is 0, the absolute value of the coefficient of the corresponding position may be 1. When the value of the abs_level_gt1_flag is 1, the level value remAbsLevel to be coded later may be as is expressed in Equation 2 below.

remAbsLevel=remAbsLevel−1 [Equation 2]

As in Equation 3 below through the syntax element par_level_flag, the least significant coefficient (LSB) value of the remAbsLevel described in Equation 2 may be coded. Here, the syntax element par_level_flag [n] may represent a parity of the transform coefficient level (value) at the scanning position (n). The transform coefficient level value remAbsLevel to be coded after the coding of the syntax element par_level_flag may be updated as is expressed in Equation 4 below.

par_level_flag=remAbsLevel & 1 [Equation 3]

remAbsLevel′=remAbsLevel>>1 [Equation 4]

The syntax element abs_level_gt3_flag may represent whether the remAbsLevel′ at the corresponding scanning position (n) is greater than 3. Coding of the syntax element abs_remainder may be performed only when the syntax element abs_level_gt3_flag is 1. The relationship between the coeff, which is the actual transform coefficient value, and the respective syntax elements may be summarized as is expressed in Equation 5 below, and Table 12 below may represent examples related to Equation 5. Finally, the sign of each coefficient may be coded by using the syntax element coeff_sign_flag, which is a 1-bit symbol. |coeff| may represent the transform coefficient level (value), and may also be expressed as AbsLevel for the transform coefficient.

|coeff|=sig_coeff_flag+abs_level_gt1_flag+par_level_flag+2*(abs_level_gt3flag+abs_remainder) [Equation 5]

TABLE 13

| | sig_ | abs_ | par_ | abs_ | abs_ |
|---|---|---|---|---|---|
| | coeff_ | level_ | level_ | level_ | remainder/dec_ |
| \|coeff\| | flag | gt1_flag | flag | gt3_flag | abs_level |
| 0 | 0 | | | | |
| 1 | 1 | 0 | | | |
| 2 | 1 | 1 | 0 | | |
| 3 | 1 | 1 | 1 | 0 | |
| 4 | 1 | 1 | 0 | 1 | 0 |
| 5 | 1 | 1 | 1 | 1 | 0 |
| 6 | 1 | 1 | 0 | 1 | 1 |
| 7 | 1 | 1 | 1 | 1 | 1 |
| 8 | 1 | 1 | 0 | 1 | 2 |
| 9 | 1 | 1 | 1 | 1 | 2 |
| 10 | 1 | 1 | 0 | 1 | 3 |
| 11 | 1 | 1 | 1 | 1 | 3 |
| . . . | . . . | . . . | . . . | | |

In an embodiment, the par_level_flag may represent an example of a parity level flag for the parity of the transform coefficient level for the quantized transform coefficient, the abs_level_gt1_flag may represent an example of a first transform coefficient level flag about whether the transform coefficient level or the level (value) to be coded is greater than a first threshold, and the abs_level_gt1_flag may represent an example of a second transform coefficient level flag about whether the transform coefficient level or the level (value) to be coded is greater than a second threshold.

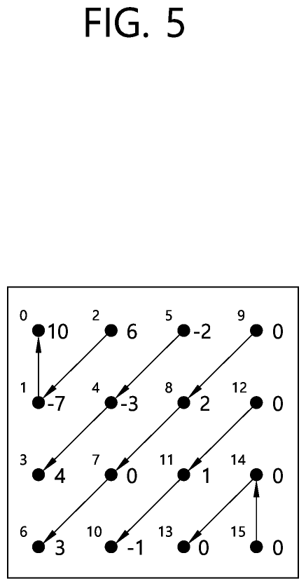

FIG. 5 is a diagram illustrating an example of transform coefficients within a 4×4 block.

The 4×4 block illustrated in FIG. 5 may represent an example of quantized coefficients. The block illustrated in FIG. 5 may be a 4×4 transform block, or a 4×4 sub-block of 8×8, 16×16, 32×32, and 64×64 transform blocks. The 4×4 block illustrated in FIG. 5 may represent a luma block or a chroma block. Coding results for the inverse diagonally scanned coefficients illustrated in FIG. 5 may be represented, for example, as in Table 3. In Table 14, the scan_pos may represent the position of the coefficient according to the inverse diagonal scan. The scan_pos 15 may represent the coefficient which is first scanned, that is, of the lower right corner in the 4×4 block, and the scan_pos 0 may represent the coefficient, which is lastly scanned, that is, of the upper left corner in the 4×4 block. Meanwhile, in an embodiment, the scan_pos may also be referred to as a scan position. For example, the scan_pos 0 may be referred to as a scan position 0.

TABLE 14

| | | | | | | | | | | | | | | | | |
|---|---|---|---|---|---|---|---|---|---|---|---|---|---|---|---|---|
| scan_pos | 15 | 14 | 13 | 12 | 11 | 10 | 9 | 8 | 7 | 6 | 5 | 4 | 3 | 2 | 1 | 0 |
| coefficients | 0 | 0 | 0 | 0 | 1 | −1 | 0 | 2 | 0 | 3 | −2 | −3 | 4 | 6 | −7 | 10 |
| sig_coeff_ | 0 | 0 | 0 | 0 | 1 | 1 | 0 | 1 | 0 | 1 | 1 | 1 | 1 | 1 | | |
| flag | | | | | | | | | | | | | | | | |
| abs_level_ | | | | | 0 | 0 | | 1 | | 1 | 1 | 1 | 1 | 1 | | |
| gt1_flag | | | | | | | | | | | | | | | | |
| par_level_ | | | | | | | | 0 | | 1 | 0 | 1 | 0 | 0 | | |
| flag | | | | | | | | | | | | | | | | |
| abs_level_ | | | | | | | | | | | | | 1 | 1 | | |
| gt3_flag | | | | | | | | | | | | | | | | |
| abs_ | | | | | | | | | | | | | 0 | 1 | | |
| remainder | | | | | | | | | | | | | | | | |
| dec_abs_ | | | | | | | | | | | | | | | 7 | 10 |
| level | | | | | | | | | | | | | | | | |
| coeff_sign_ | 0 | 0 | 0 | 0 | 0 | 1 | 0 | 0 | 0 | 0 | 1 | 1 | 0 | 0 | 1 | 0 |
| flag | | | | | | | | | | | | | | | | |

Meanwhile, CABAC provides high performance but has a disadvantage of poor throughput performance. This is caused by the regular coding engine of the CABAC, and the regular coding uses the updated probability state and range through the coding of the previous bin, thereby showing high data dependency, and taking a long time to read the probability section and determine the current state. It is possible to solve the throughput problem of the CABAC by limiting the number of context-coded bins. Accordingly, the sum of bins used to express the syntax elements sig_coeff_flag, abs_level_gt1_flag, and par_level_flag is restricted to 28 in the case of the 4×4 sub-block, and restricted to 6 (remBinsPass1) in the case of the 2×2 sub-block according to the size of the sub-block as in Tables 1 to 6 or Tables 7 to 11, and the number of context-coded bins of the syntax element abs_level_gt3_flag may be restricted to 4 in the case of the 4×4 sub-block and restricted to 2 (remBinsPass2) in the case of the 2×2 sub-block. When all of the restricted context-coded bins are used to code the context element, the remainder coefficients may be binarized without using the CABAC to perform the bypass coding.

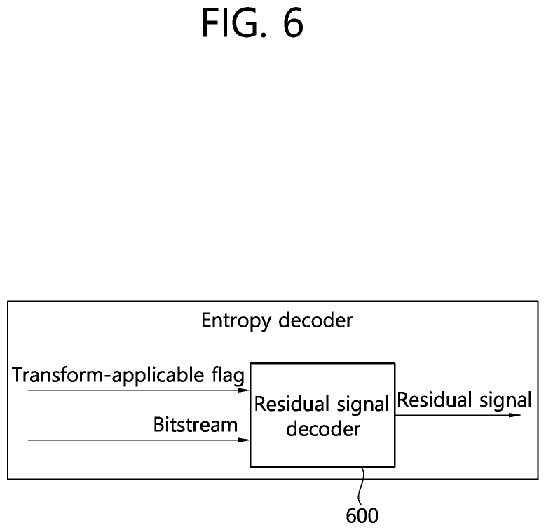

FIG. 6 is a diagram illustrating a residual signal decoder according to an embodiment of this document.

Meanwhile, as described with reference to Tables 1 to 6 or 7 to 10, whether a transform is applied to a corresponding block may be first transmitted before a residual signal is coded. The compaction of data is performed by representing a correlation between residual signals in the transform domain, and the data is transmitted to the decoding apparatus. If the correlation between the residual signals is insufficient, the compaction of the data may not be sufficiently performed. In such a case, a transform process including a complicated calculation process may be omitted, and a residual signal in a pixel domain (spatial domain) may be transmitted to the decoding apparatus.

The residual signal in the pixel domain on which a transform has not been performed has characteristics (a distribution of residual signals, an absolute level of each residual signal, etc.) different from those of a residual signal in a normal transform domain. Accordingly, hereinafter, according to an embodiment of this document, a residual signal coding method for efficiently transmitting such a signal to the decoding apparatus is proposed.

As illustrated in FIG. 6, a flag-indicating-whether-a-transform-is-applied indicating whether a transform is applied to a corresponding transform block and a bitstream (or information on a coded binarization code) may be input to a residual signal decoder 600. A (decoded) residual signal may be output from the residual signal decoding unit.

The flag-indicating-whether-a-transform-is-applied may be represented as a transform flag, a transform skip flag, or a syntax element transform_skip_flag. The coded binarization code may be input to the residual signal decoder 600 through a binarization process.

The residual signal decoder 600 may be included in the entropy decoder of the decoding apparatus. Furthermore, in FIG. 6, the flag-indicating-whether-a-transform-is-applied and the bitstream are divided and described for convenience of description, but the flag-indicating-whether-a-transform-is-applied may be included in the bitstream. Alternatively, the bitstream may include information (if a transform is applied, syntax element transform_skip_flag=0) on transform coefficients or information (if a transform is not applied, transform_skip_flag=1) on (a value of) a residual sample, in addition to the flag-indicating-whether-a-transform-is-applied. The information on the transform coefficients may include pieces of information (or syntax elements) indicated in Tables 1 to 6 or 7 to 10, for example.

The transform skip flag may be transmitted in a transform block unit. For example, in Tables 1 to 6, the transform skip flag is limited to a specific block size (including a condition in which transform_skip_flag is parsed only when the size of a transform block is 4×4 or less). In an embodiment, the size of a block for determining whether to parse the transform skip flag may be variously set. The sizes of log 2TbWidth and log 2TbHeight may be determined as variables wN and hN, respectively. Each of wN and hN may have one of the following values illustrated in Equation 6, for example.

wN={2,3,4,5,6}

hN={2,3,4,5,6} [Equation 6]

For example, a syntax element to which wN and hN having the values of Equation 6 may be applied may be indicated as in Table 15.

TABLE 15

| | |
|---|---|
| if( transform_skip_enabled_flag && | |
| ( cIdx ! = 0 \| \| cu_mts_flag[ x0 ][ y0 ] = = 0 ) && | |
| ( log2TbWidth <= wN ) && ( log2TbHeight <= hN ) ) | |
| transform_skip_flag[ x0 ][ y0 ][ cIdx ] | ae(v) |

For example, each of wN and hN may have a value of 5. In this case, the transform skip flag may be signaled to a block having a width smaller than or equal to 32 and a height smaller than or equal to 32. Alternatively, each of wN and hN may have a value of 6. In this case, the transform skip flag may be signaled to a block having a width smaller than or equal to 64 and a height smaller than or equal to 64. For example, wN and hN may have may have a value of 2, 3, 4, 5 or 6 as in Equation 6 and may have different values. Furthermore, the width and height of a block on which a transform skip flag may be signaled may be determined based on a value of wN and hN.

As described above, a method of decoding a residual signal may be determined based on the transform skip flag. Complexity can be reduced and coding efficiency can be improved in an entropy decoding process by efficiently processing signals having different statistical characteristics through the proposed method.

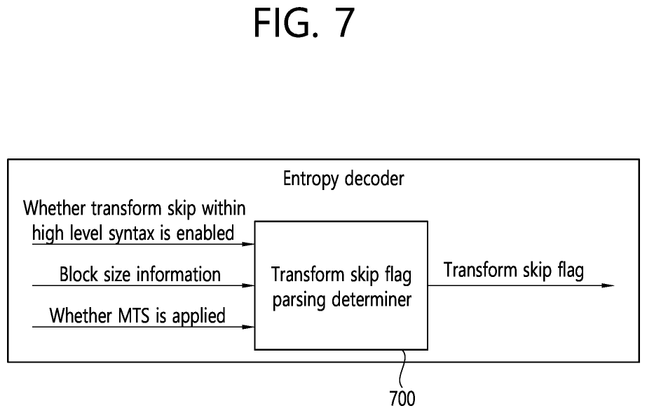

FIG. 7 is a diagram illustrating a transform skip flag parsing determiner according to an embodiment of this document.

Meanwhile, as described with reference to Tables 1 to 6 or 7 to 10, according to an embodiment, whether a transform is applied to a corresponding block may be first transmitted before a residual signal is coded. The compaction of data is performed by representing a correlation between residual signals in the transform domain, and the data is transmitted to the decoder. If the correlation between the residual signals is insufficient, the compaction of the data may be sufficiently performed. In such a case, a transform process including a complicated calculation process may be omitted, and a residual signal in the pixel domain (spatial domain) may be transmitted to the decoder. A residual signal in the pixel domain in which a transform has not been performed has characteristics (a distribution of residual signals, an absolute level of each residual signal, etc.) different from those of a residual signal in a normal transform domain. Accordingly, there is proposed a residual signal coding method for efficiently transmitting such a signal to the decoder is proposed.

A transform skip flag may be transmitted in a transform block unit. For example, the signaling of the transform skip flag is limited to a specific block size (including a condition in which transform_skip_flag is parsed only when the size of a transform block is 4×4 or less). In an embodiment, the condition in which whether to parse the transform skip flag is determined may be defined as the number of pixels or samples within a block not information on the width or height of a block. That is, to use the product of log 2TbWidth and log 2TbHeight, among conditions used to parse a transform skip flag (e.g., a syntax element transform_skip_flag), may be defined. Alternatively, the transform skip flag may be parsed based on the product of width (e.g., log 2TbWidth) and height (e.g., log 2TbHeight) of a block. Alternatively, whether to parse the transform skip flag may be determined based on a value obtained by multiplying the width (e.g., log 2TbWidth) and height (e.g., log 2TbHeight) of a block. For example, each of log 2TbWidth and log 2TbHeight may have one of the following values illustrated in Equation 7.

log 2TbWidth={1,2,3,4,5,6}

log 2TbHeight={1,2,3,4,5,6} [Equation 7]

According to an embodiment, if whether to parse a transform skip flag is determined based on the number of samples within a block, blocks having various shapes may be included in a transform exclusion block (in which a transform skip flag is not parsed), compared to a case where whether to parse a transform skip flag is determined based on the width and height of a block.

For example, if each of log 2TbWidth and log 2TbHeight is defined as 2, only a block having a 2×4, 4×2 or 4×4 size may be included in a transform exclusion block. If control is performed based on the number of samples, a block having the number of samples of 16 is included in the transform exclusion block. Accordingly, not only the block having the 2×4, 4×2 or 4×4 size, but a block having a 2×8 or 8×2 size may be included in the transform exclusion block.

A method of decoding a residual signal may be determined based on the transform skip flag. According to the aforementioned embodiment, complexity can be reduced and coding efficiency can be improved in an entropy decoding process by efficiently processing signals having different statistical characteristics.

For example, as illustrated in FIG. 7, information on whether a transform skip within a high level syntax is enabled, block size information, and information on whether multiple transform selection (MTS) is applied may be input to the transform skip flag parsing determiner 700. A transform skip flag may be output from the transform skip flag parsing determiner 700. The aforementioned pieces of information may be included in a bitstream or a syntax. The transform skip flag parsing determiner 700 may be included in the entropy decoder of the decoding apparatus. For example, a method of determining a transform skip flag based on the aforementioned pieces of information may be as follows.

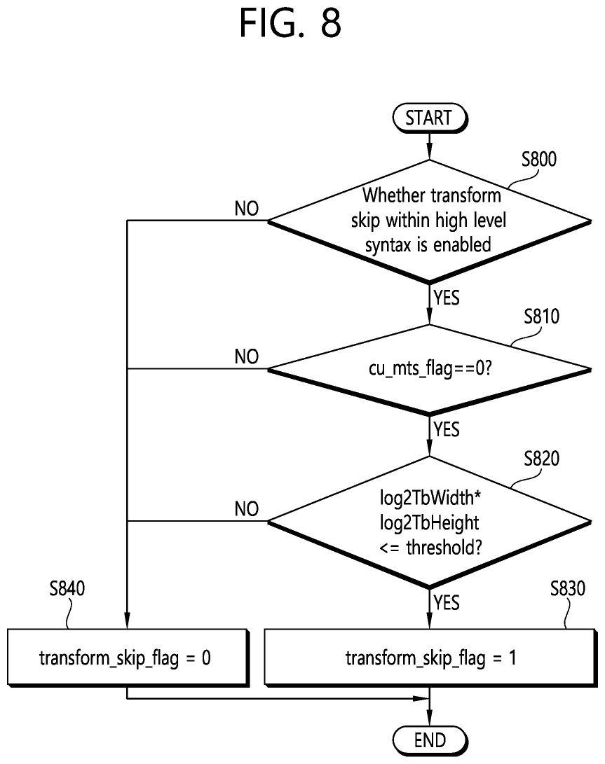

FIG. 8 is a flowchart for describing a method of decoding a transform skip flag according to an embodiment of this document.

The aforementioned embodiment is described as follows with reference to FIG. 8.

First, whether a transform skip within a high level syntax is enabled may be determined (S800). For example, a transform skip within a high level syntax is enabled may be determined based on information (e.g., transform_skip_enabled_flag) on whether a transform skip within a high level syntax is enabled. For example, the information (e.g., transform_skip_enabled_flag) on whether a transform skip is enabled may be signaled in a picture parameter set (PPS). In this case, the meaning that the transform skip within the high level syntax is enabled may indicate that a transform skip is enabled with respect to a slice/block that refers to a corresponding high level syntax. Whether a transform skip is substantially applied to a block for which a transform skip is enabled may be determined based on the aforementioned transform skip flag.

For example, if the transform skip within a high level syntax is enabled, whether a value of a syntax element cu_mts_flag within the syntax is 0 may be determined (S810). For example, whether a value of the syntax element cu_mts_flag is 0 may be determined based on information on whether multiple transform selection (MTS) is applied. Alternatively, the information on whether the MTS is applied may include the syntax element cu_mts_flag. Alternatively, the information on whether the MTS is applied may also include a syntax element sps_mts_enabled_flag, and may be determined based on a value of the syntax element sps_mts_enabled_flag.

For example, when a value of the syntax element cu_mts_flag is 0, whether the product of log 2TbWidth and log 2TbHeight is smaller than or equal to a threshold may be determined (S820). Alternatively, whether a value of the product of a log value in which the base of the width of a current block is 2 and a log value in which the base of the height of the current block is 2 is smaller than a threshold may be determined. Alternatively, whether a value of the product of the width and height of a current block is smaller than a threshold may be determined. For example, whether the product of log 2TbWidth and log 2TbHeight is smaller than or equal to a threshold may be determined based on block size information. The block size information may include information on the width and height of the current block. Alternatively, the block size information may include information on a log value in which the base of the width and height of the current block is 2.

For example, when the product of log 2TbWidth and log 2TbHeight is smaller than or equal to the threshold, a value of the transform skip flag (or the syntax element transform_skip_flag) may be determined as 1 (S830). Alternatively, the transform skip flag having a value of 1 may be parsed. That is, the current block may be included in a transform exclusion block based on the transform skip flag, and a transform may not be applied to the current block.

For example, if the transform skip within a high level syntax is not enabled, when a value of the syntax element cu_mts_flag is not 0 or when the product of log 2TbWidth and log 2TbHeight is greater than the threshold, a value of the transform skip flag (or syntax element transform_skip_flag) may be determined as 0 (S840). Alternatively, the transform skip flag having a value of 0 may be parsed. Alternatively, the transform skip flag may not be parsed. That is, a current block may not be included in a transform exclusion block based on the transform skip flag, and a transform may be applied to the current block.

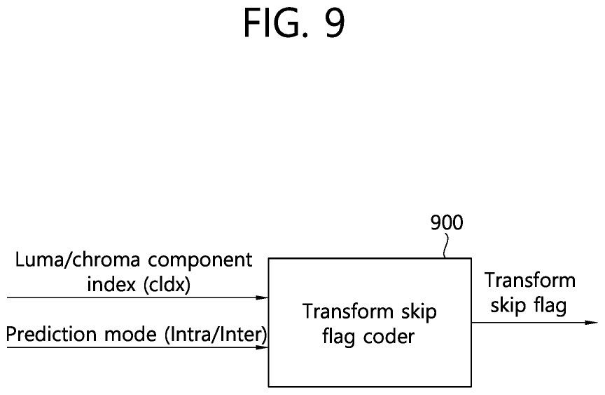

FIG. 9 is a diagram illustrating a transform skip flag coder according to an embodiment of this document.

If coding is performed on any image, the coding may be performed on the image by determining a block as a coding unit and dividing a similar area into square or rectangular blocks. In this case, assuming that a luma component and a chroma component are similar, an already-coded block division structure of a luma component may be used in a chroma component without any change. In this case, the chroma component includes a relatively less complicated area than the luma component. Although the chroma component follows a block structure different from that of a block of a luma component, coding information of an image can be effectively delivered.

Meanwhile, after prediction is performed, a residual signal generated through a difference with the original may experience a transform and quantization. The compaction of a decoded image cannot be expected without great damage by omitting or reducing information of a high frequency region which is not easily recognized by the human eye through such a process with respect to an area in which many residuals occur. In this case, if a chroma component is coded, prediction accuracy may be high and energy of residual information may occur relatively small, compared to a luma component because complicated texture is not many as described above. In such a case, there may be no great difference between a case where a transform is applied and a case where a transform is not applied. To transmit the flag-indicating-whether-a-transform-is-applied to all transform blocks may act as overhead.

Furthermore, in general, intra prediction has characteristics in that it has many non-zero residual coefficients and has a higher level compared to inter prediction. The reason for this is that intra prediction is performed only within a limited range from a neighbor sample, whereas inter prediction uses, as a predicted value, a block most similar to a current block depending on temporal similarity. Accordingly, a transform skip flag may be transmitted based on a current prediction mode and what component (a luma component or a chroma component) because characteristics of a residual are greatly changed depending on the chroma prediction mode. For example, with respect to an intra-predicted block, transform skip information of a luma component is transmitted, but transform skip information of a chroma component is not transmitted. With respect to an inter predicted block, transform skip information of both a luma component and a chroma component may be transmitted. In other words, transform skip information (or a transform skip flag) may be transmitted based on whether a block is a luma component or a chroma component. Alternatively, the transform skip information may be signaled when a block is a luma component. Alternatively, the transform skip information may be signaled with respect to each of a luma component block and a chroma component block. Furthermore, the transform skip flag may be applied to only a luma component. Alternatively, the transform skip flag may also be applied to a luma component and a chroma component. Alternatively, transform skip information signaled with respect to each of a luma component and a chroma component may also be applied to each component.

For example, as illustrated in FIG. 9, information (e.g., cldx) on a luma/chroma component index and information (e.g., intra/inter) on a prediction mode may be input to a transform skip flag coder 900. A transform skip flag may be output from the transform skip flag coder 900. Alternatively, a luma/chroma component index may be input to the transform skip flag coder 900. A transform skip flag may be output from the transform skip flag coder 900. Alternatively, information on a prediction mode may be input to the transform skip flag coder 900. A transform skip flag may be output from the transform skip flag coder 900. Furthermore, the transform skip flag may be included in residual related information (or residual related syntax).

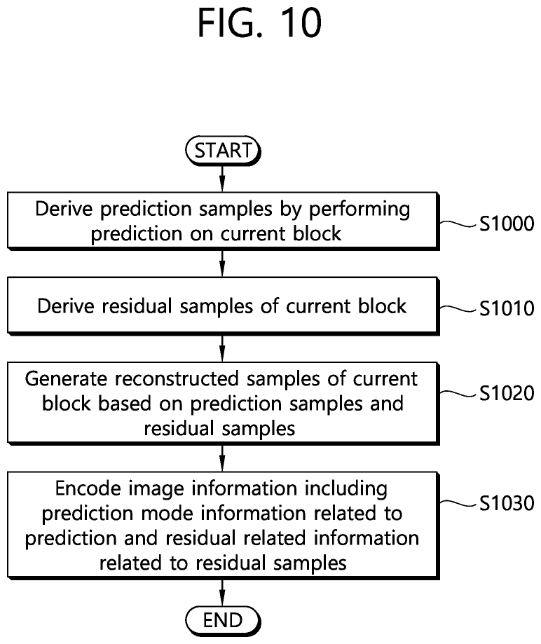

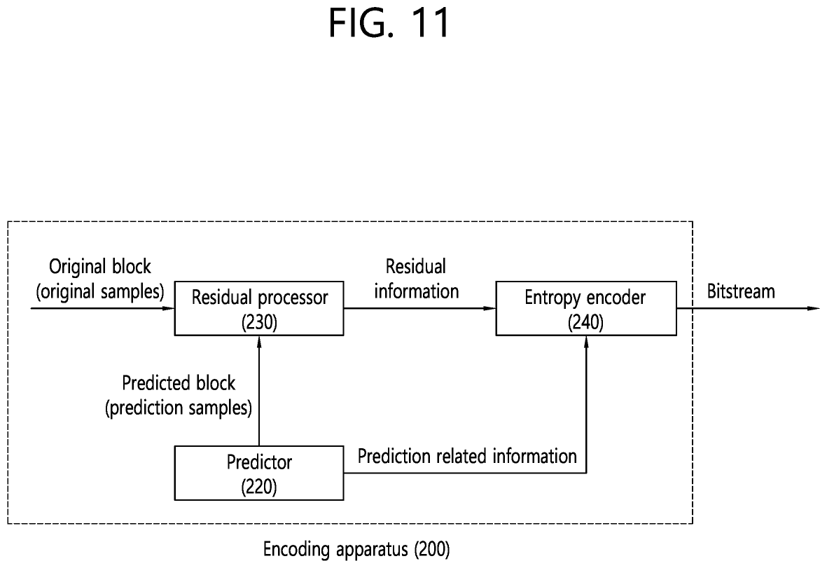

FIGS. 10 and 11 schematically illustrate examples of a video/image encoding method and related components according to an embodiment(s) of this document.

The method disclosed in FIG. 10 may be performed by the encoding apparatus disclosed in FIG. 2. Specifically, for example, S1000 in FIG. 10 may be performed by the predictor 220 of the encoding apparatus in FIG. 11. S1010 and S1020 in FIG. 10 may be performed by the residual processor 230 of the encoding apparatus in FIG. 11. S1030 in FIG. 10 may be performed by the entropy encoder 240 of the encoding apparatus in FIG. 11. The method disclosed in FIG. 10 may include the embodiments described in this document.

Referring to FIG. 10, the encoding apparatus may derive prediction samples by performing prediction on a current block (S1000). For example, the encoding apparatus may derive the prediction samples by performing prediction on the current block, and may derive information on a prediction mode in which the prediction has been performed. For example, the prediction mode may be an intra prediction mode or an inter prediction mode. For example, when the prediction mode is the intra prediction mode, the encoding apparatus may derive the prediction samples based on samples neighboring the current block. Alternatively, when the prediction mode is the inter prediction mode, the encoding apparatus may derive the prediction samples based on reference samples within a reference picture of the current block.

The encoding apparatus may derive residual samples of the current block (S1010). For example, the encoding apparatus may derive the residual samples (or residual block) of the current block based on the original samples and prediction samples (or predicted block) of the current block. In this case, the residual samples may be indicated as a residual sample array.

The encoding apparatus may generate reconstructed samples of the current block based on the prediction samples and the residual samples (S1020). For example, the encoding apparatus may generate the reconstructed samples (or a reconstructed block) by adding the residual samples (or residual block) to the prediction samples (or predicted block).

The encoding apparatus may encode image information, including prediction mode information related to the prediction and residual related information related to the residual samples (S1030).

For example, the encoding apparatus may generate the prediction mode information based on the prediction mode. The image information may include the prediction mode information. That is, if prediction is performed on the current block in the intra prediction mode, the prediction mode information may include information on the intra prediction mode. If prediction is performed on the current block in the inter prediction mode, the prediction mode information may include information on the inter prediction mode.

For example, the encoding apparatus may generate the residual related information including information on the residual samples (or residual sample array). The image information may include the residual related information. The information on the residual samples or the residual related information may include information on a transform coefficient related to the residual samples.

For example, the residual related information may include residual coding information (or residual coding syntax). Alternatively, the residual related information may include transform unit information (or transform unit syntax). Alternatively, the residual related information may include the residual coding information and the transform unit information.

For example, whether the residual related information includes a transform skip flag may be determined based on whether the current block is a luma component block or a chroma component block. That is, the residual related information may include the transform skip flag based on a component of the current block.

For example, the residual related information may include the transform skip flag for the luma component block based on the current block, that is, the luma component block. That is, when the current block is the luma component block, the residual related information may include the transform skip flag for the luma component block. For example, when a non-zero significant coefficient is present in the luma component block, the residual related information may include the transform skip flag for the luma component block. This may be represented by the aforementioned syntax element last_sig_coeff_x_prefix, last_sig_coeff_y_prefix, last_sig_coeff_x_suffix. last_sig_coeff_y_suffix, coded_sub_block_flag, or sig_coeff_flag related to the non-zero significant coefficient.

For example, the residual related information may not include the transform skip flag for the chroma component block based on the current block, that is, the chroma component block. That is, when the current block is the chroma component block, the residual related information may not include the transform skip flag for the chroma component block. For example, the transform skip flag for the chroma component block may not be explicitly signaled based on the current block, that is, the chroma component block. That is, when the current block is the chroma component block, the transform skip flag for the chroma component block may not be explicitly signaled.

For example, the transform skip flag may be signaled only when the current block is a luma component, and thus may be applied to only a luma component. Alternatively, the transform skip flag may be signaled only when the current block is a luma component, but may also be applied to a luma component and a chroma component corresponding to the luma component.

For example, whether the residual related information includes the transform skip flag may be determined based on a prediction mode indicated by the prediction mode information. For example, as described with reference to FIG. 9, the residual related information may include the transform skip flag based on a component of the current block and the prediction mode.

For example, the residual related information may include the transform skip flag for the luma component block and may not include the transform skip flag for the chroma component block, based on the prediction mode, that is, an intra prediction mode. That is, when a prediction mode indicated by the prediction mode information is an intra prediction mode, the residual related information may include the transform skip flag for the luma component block and may not include the transform skip flag for the chroma component block. For example, the residual related information may include the transform skip flag for the luma component block and the transform skip flag for the chroma component block, based on the prediction mode, that is, an inter prediction mode. That is, when a prediction mode indicated by the prediction mode information is an inter prediction mode, the residual related information may include the transform skip flag for the luma component block and the transform skip flag for the chroma component block.

For example, the residual related information may include the transform skip flag based on the width and height of the current block. For example, the residual related information may include the transform skip flag based on the width of the current block smaller than or equal to a first threshold and the height of the current block smaller than or equal to a second threshold. For example, the width may be indicated as log 2TbWidth, and the height may be indicated as log 2TbHeight. The first threshold may be indicated as wN, and the second threshold may be indicated as hN. Each of wN and hN may be 2, 3, 4, 5 or 6.

For example, the first threshold may be 32 or 64, and the second threshold may be the same as the first threshold. For example, when each of the first threshold and the second threshold is 32, each of wN and hN may have a value of 5. The transform skip flag may be signaled with respect to a block having a width smaller than or equal to 32 and a height smaller than or equal to 32. For example, when each of the first threshold and the second threshold is 64, each of wN and hN may have a value of 6. The transform skip flag may be signaled with respect to a block having a width smaller than or equal to 64 and a height smaller than or equal to 64. In other words, the width and height of a block for which the transform skip flag may be signaled may be determined based on values of wN and hN.

For example, the residual related information may include the transform skip flag based on the number of samples included in the current block. For example, the residual related information may include the transform skip flag based on the number of samples included in the current block, which is smaller than or equal to a third threshold. That is, when the number of samples included in the current block is smaller than or equal to the third threshold, the residual related information may include the transform skip flag. For example, the number of samples included in the current block may be derived based on the width and height of the current block. In FIG. 8, the width may be indicated as log 2TbWidth, and the height may be indicated as log 2TbHeight. The third threshold may be indicated as Threshold.

For example, the current block may include a non-square block. In other words, although the width and height of the current block are different, if the width is smaller than or equal to the first threshold and the height is smaller than or equal to the second threshold, a transform skip flag for the current block may be signaled. Alternatively, although the width and height of the current block are different, if the number of samples within the current block is smaller than or equal to the third threshold, a transform skip flag for the current block may be signaled. Alternatively, although the width and height of the current block are different, if each of the width and height of the current block is smaller than or equal to 32 or 64, a transform skip flag for the current block may be signaled.

The transform skip flag may represent whether a transform skip has been applied to the current block. That is, whether a residual signal (or information on a residual) for the current block is signaled in a pixel domain (spatial domain) without a transform or whether a transform is performed on the residual signal and the residual signal is signaled in a transform domain may be determined based on the transform skip flag. The transform skip flag may be indicated as a flag-indicating-whether-a-transform-is-applied, a transform skip flag, or a syntax element transform_skip_flag.

For example, residual related information may include or may not include the transform skip flag as described above. For example, when the residual related information includes the transform skip flag, this may indicate that residual samples of the current block have been derived without a transform. A residual signal (or information on a residual) for the current block may be signaled in the pixel domain (spatial domain) without a transform. Alternatively, when the residual related information does not include the transform skip flag, this may indicate that residual samples of the current block have been derived by performing a transform. A transform may be performed on a residual signal (or information on a residual) for the current block, and the residual signal may be signaled in the transform domain.

The encoding apparatus may generate a bitstream by encoding image information including some or all of the aforementioned pieces of information (or syntax elements). Alternatively, the encoding apparatus may output the image information in the form of a bitstream. Furthermore, the bitstream may be transmitted to the decoding apparatus over a network or through a storage medium. Alternatively, the bitstream may be stored in a computer-readable storage medium.

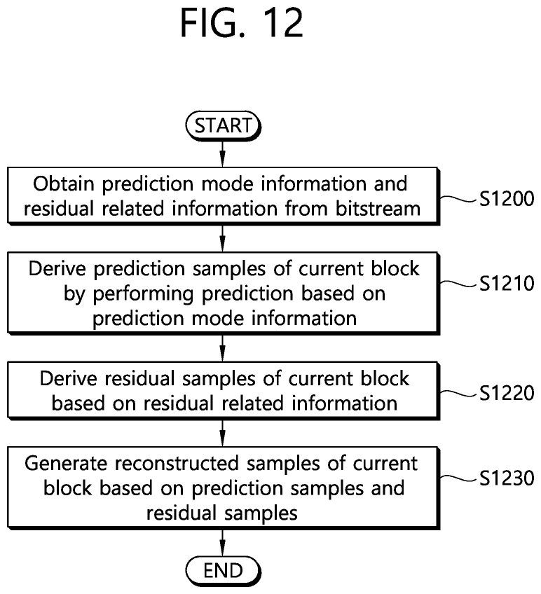

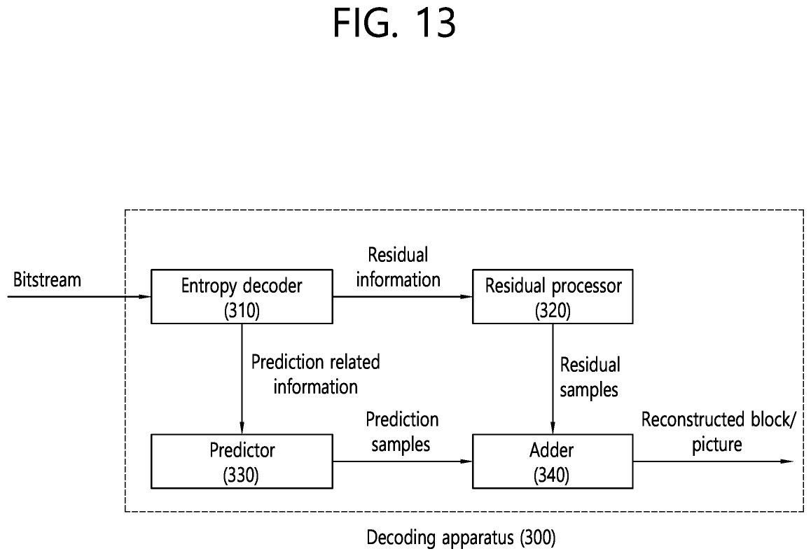

FIGS. 12 and 13 schematically illustrate examples of a video/image encoding method and related components according to an embodiment(s) of this document.

FIGS. 12 and 13 schematically illustrate examples of the video/image encoding method and related components according to an embodiment(s) of this document. The method disclosed in FIG. 12 may be performed by the decoding apparatus disclosed in FIG. 3. Specifically, for example, S1200 in FIG. 12 may be performed by the entropy decoder 310 of the decoding apparatus of FIG. 13. S1210 in FIG. 12 may be performed by the predictor 330 of the decoding apparatus of FIG. 13. S1220 in FIG. 12 may be performed by the residual processor 320 of the decoding apparatus of FIG. 13. S1230 in FIG. 12 may be performed by the adder 340 of the decoding apparatus of FIG. 13. The method disclosed in FIG. 12 may include the embodiments described in this document.

Referring to FIG. 12, the decoding apparatus may obtain prediction mode information and residual related information from a bitstream (S1200). Alternatively, the decoding apparatus may obtain the prediction mode information or the residual related information by (entropy) decoding the bitstream.

For example, the prediction mode information may include information on a prediction mode of a current block. Alternatively, the prediction mode information may include information on an intra prediction mode or an inter prediction mode.

For example, the residual related information may include residual coding information (or residual coding syntax). Alternatively, the residual related information may include transform unit information (or transform unit syntax). Alternatively, the residual related information may include residual coding information and transform unit information.

For example, whether the residual related information includes a transform skip flag may be determined based on whether the current block is a luma component block or a chroma component block. That is, the residual related information may include the transform skip flag based on a component of the current block.

For example, the residual related information may include the transform skip flag for the luma component block based on the current block, that is, the luma component block. That is, when the current block is the luma component block, the residual related information may include the transform skip flag for the luma component block. For example, when a non-zero significant coefficient is present in the luma component block, the residual related information may include the transform skip flag for the luma component block. This may be represented by the aforementioned syntax element last_sig_coeff_x_prefix, last_sig_coeff_y_prefix, last_sig_coeff_x_suffix. last_sig_coeff_y_suffix, coded_sub_block_flag, or sig_coeff_flag related to the non-zero significant coefficient.

For example, the residual related information may not include the transform skip flag for the chroma component block based on the current block, that is, the chroma component block. That is, when the current block is the chroma component block, the residual related information may not include the transform skip flag for the chroma component block. For example, the transform skip flag for the chroma component block may not be explicitly signaled based on the current block, that is, the chroma component block. That is, when the current block is the chroma component block, the transform skip flag for the chroma component block may not be explicitly signaled.

For example, the transform skip flag may be signaled only when the current block is a luma component, and thus may be applied to only a luma component. Alternatively, the transform skip flag may be signaled only when the current block is a luma component, but may also be applied to a luma component and a chroma component corresponding to the luma component.

For example, whether the residual related information includes the transform skip flag may be determined based on a prediction mode indicated by the prediction mode information. For example, as described with reference to FIG. 9, the residual related information may include the transform skip flag based on a component of the current block and the prediction mode.

For example, the residual related information may include the transform skip flag for the luma component block and may not include the transform skip flag for the chroma component block, based on the prediction mode, that is, an intra prediction mode. That is, when a prediction mode indicated by the prediction mode information is an intra prediction mode, the residual related information may include the transform skip flag for the luma component block and may not include the transform skip flag for the chroma component block. For example, the residual related information may include the transform skip flag for the luma component block and the transform skip flag for the chroma component block, based on the prediction mode, that is, an inter prediction mode. That is, when a prediction mode indicated by the prediction mode information is an inter prediction mode, the residual related information may include the transform skip flag for the luma component block and the transform skip flag for the chroma component block.

For example, the residual related information may include the transform skip flag based on the width and height of the current block. For example, the residual related information may include the transform skip flag based on the width of the current block smaller than or equal to a first threshold and the height of the current block smaller than or equal to a second threshold. For example, the width may be indicated as log 2TbWidth, and the height may be indicated as log 2TbHeight. The first threshold may be indicated as wN, and the second threshold may be indicated as hN. Each of wN and hN may be 2, 3, 4, 5 or 6.

For example, the first threshold may be 32 or 64, and the second threshold may be the same as the first threshold. For example, when each of the first threshold and the second threshold is 32, each of wN and hN may have a value of 5. The transform skip flag may be signaled with respect to a block having a width smaller than or equal to 32 and a height smaller than or equal to 32. For example, when each of the first threshold and the second threshold is 64, each of wN and hN may have a value of 6. The transform skip flag may be signaled with respect to a block having a width smaller than or equal to 64 and a height smaller than or equal to 64. In other words, the width and height of a block for which the transform skip flag may be signaled may be determined based on values of wN and hN.

For example, the residual related information may include the transform skip flag based on the number of samples included in the current block. For example, the residual related information may include the transform skip flag based on the number of samples included in the current block, which is smaller than or equal to a third threshold. That is, when the number of samples included in the current block is smaller than or equal to the third threshold, the residual related information may include the transform skip flag. For example, the number of samples included in the current block may be derived based on the width and height of the current block. In FIG. 8, the width may be indicated as log 2TbWidth, and the height may be indicated as log 2TbHeight. The third threshold may be indicated as Threshold.

For example, the current block may include a non-square block. In other words, although the width and height of the current block are different, if the width is smaller than or equal to the first threshold and the height is smaller than or equal to the second threshold, a transform skip flag for the current block may be signaled. Alternatively, although the width and height of the current block are different, if the number of samples within the current block is smaller than or equal to the third threshold, a transform skip flag for the current block may be signaled. Alternatively, although the width and height of the current block are different, if each of the width and height of the current block is smaller than or equal to 32 or 64, a transform skip flag for the current block may be signaled.

The transform skip flag may represent whether a transform skip has been applied to the current block. That is, whether a residual signal (or information on a residual) for the current block is signaled in a pixel domain (spatial domain) without a transform or whether a transform is performed on the residual signal and the residual signal is signaled in a transform domain may be determined based on the transform skip flag. The transform skip flag may be indicated as a flag-indicating-whether-a-transform-is-applied, a transform skip flag, or a syntax element transform_skip_flag.

The decoding apparatus may derive prediction samples of the current block by performing prediction based on the prediction mode information (S1210). For example, the decoding apparatus may derive a prediction mode of the current block based on the prediction mode information. For example, the prediction mode information may include information on an intra prediction mode or information on an inter prediction mode, and the prediction mode of the current block may be derived as an intra prediction mode or an inter prediction mode based on the information.

For example, the decoding apparatus may derive the prediction samples of the current block based on the prediction mode. For example, when the prediction mode is an intra prediction mode, the decoding apparatus may derive the prediction samples based on samples neighboring the current block. Alternatively, when the prediction mode is an inter prediction mode, the decoding apparatus may derive the prediction samples based on reference samples within a reference picture of the current block.

The decoding apparatus may derive residual samples of the current block based on the residual related information (S1220). For example, the residual related information may include information on a transform coefficient related to the residual samples. Alternatively, the residual related information may include a transform skip flag.

For example, if the residual related information includes the transform skip flag, a residual signal (or information on a residual) for the current block may be signaled in the pixel domain (spatial domain) without a transform. Alternatively, if the residual related information does not include the transform skip flag, a transform may be performed on a residual signal (or information on a residual) for the current block, and the residual signal may be signaled in the transform domain. For example, the decoding apparatus may derive the residual samples based on a residual signal without a transform or may derive the residual samples based on a residual signal on which a transform has not been performed or which is signaled.

The decoding apparatus may generate reconstructed samples of the current block based on the prediction samples and the residual samples (S1230). Alternatively, the decoding apparatus may derive a reconstructed block or a reconstructed picture based on the reconstructed samples. Thereafter, as described above, the decoding apparatus may apply an in-loop filtering procedure, such as a deblocking filtering and/or SAO procedure, to the reconstructed picture in order to improve subjective/objective picture quality, if necessary.

The decoding apparatus may obtain image information including some or all of the aforementioned pieces of information (or syntax elements) by decoding a bitstream.

Furthermore, the bitstream may be stored in a computer-readable digital storage medium, and may cause the aforementioned decoding method to be performed.

In the aforementioned embodiments, while the methods are described based on the flowcharts as a series of steps or blocks, the present document is not limited to the order of steps, and a certain step may occur in different order from or simultaneously with a step different from that described above. In addition, those skilled in the art will understand that the steps shown in the flowchart are not exclusive and other steps may be included or one or more steps in the flowcharts may be deleted without affecting the scope of the present document.

The aforementioned method according to the present document may be implemented in the form of software, and the encoding apparatus and/or the decoding apparatus according to the present document may be included in the apparatus for performing image processing of, for example, a TV, a computer, a smartphone, a set-top box, a display device, and the like.

When the embodiments in the present document are implemented in software, the aforementioned method may be implemented as a module (process, function, and the like) for performing the above-described function. The module may be stored in a memory and executed by a processor. The memory may be located inside or outside the processor, and may be coupled with the processor by various well-known means. The processor may include application-specific integrated circuits (ASICs), other chipsets, logic circuits, and/or data processing devices. The memory may include a read-only memory (ROM), a random access memory (RAM), a flash memory, a memory card, a storage medium and/or other storage devices.

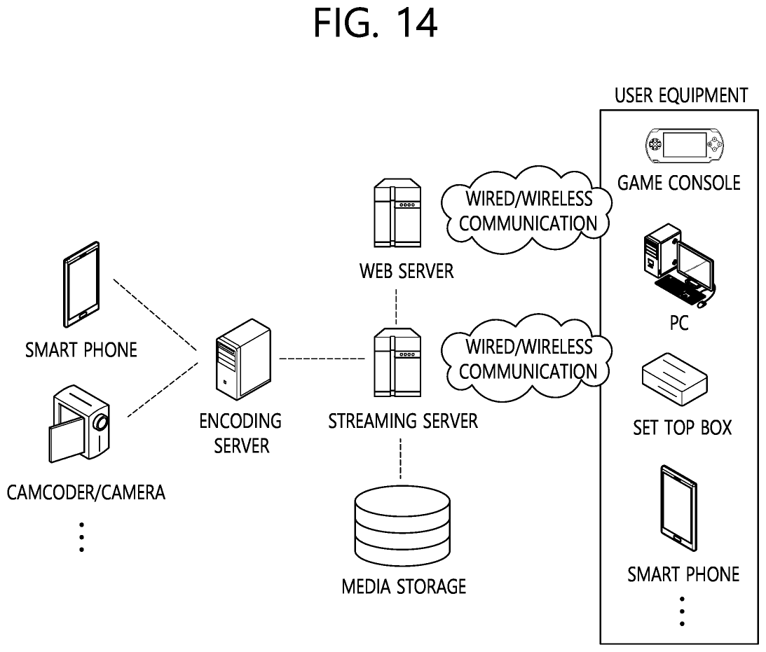

FIG. 14 schematically illustrates a structure of a contents streaming system.

That is, the embodiments described in the present document may be performed by being implemented on a processor, a microprocessor, a controller, or a chip. For example, the functional units illustrated in each drawing may be performed by being implemented on the computer, the processor, the microprocessor, the controller, or the chip.

In addition, the decoding apparatus and the encoding apparatus to which the present document is applied may be included in a multimedia broadcast transceiver, a mobile communication terminal, a home cinema video device, a digital cinema video device, a surveillance camera, a video communication device, a real-time communication device such as video communication, a mobile streaming device, a storage medium, a camcorder, a Video on Demand (VoD) service provider, an Over the top video (OTT video) device, an Internet streaming service provider, a three-dimensional (3D) video device, a video telephony video device, and a medical video device, and the like, and may be used to process video signals or data signals. For example, the Over the top video (OTT video) device may include a game console, a Blu-ray player, an Internet-connected TV, a home theater system, a smartphone, a tablet PC, a Digital Video Recorder (DVR), and the like.

In addition, the processing method to which the present document is applied may be produced in the form of a program executed by a computer, and may be stored in a computer readable recording medium. The multimedia data having a data structure according to the present document may also be stored in the computer readable recording medium. The computer readable recording medium includes all kinds of storage devices and distributed storage devices in which computer readable data are stored. The computer readable recording medium includes, for example, a Blu-ray Disc (BD), a Universal Serial Bus (USB), a ROM, a PROM, an EPROM, an EEPROM, a RAM, a CD-ROM, a magnetic tape, a floppy disk, and an optical data storage device. In addition, the computer readable recording medium includes media implemented in the form of a carrier wave (for example, transmission via the Internet). In addition, the bitstream generated by the encoding method may be stored in the computer readable recording medium or transmitted through wired/wireless communication networks. In addition, the embodiments of the present document may be implemented as a computer program product by a program code, and the program code may be executed on the computer according to the embodiments of the present document. The program code may be stored on a computer readable carrier by the computer.

In addition, the contents streaming system to which the present document is applied may largely include an encoding server, a streaming server, a web server, a media storage, a user device, and a multimedia input device.

The encoding server serves to compact the contents, which are input from multimedia input devices such as a smartphone, a camera, and a camcorder into digital data, to generate the bitstream and to transmit the bitstream to the streaming server. As another example, when the multimedia input devices such as a smartphone, a camera, and a camcorder directly generate the bitstream, the encoding server may be omitted. The bitstream may be generated by the encoding method or the bitstream generating method to which the present document is applied, and the streaming server may temporarily store the bitstream in the process of transmitting or receiving the bitstream.

The streaming server performs the role of transmitting multimedia data to a user device based on a user request through a web server, and the web server performs the role of informing the user of which services are available. If the user requests a desired service from the web server, the web server transmits the request to the streaming server, and the streaming server transmits multimedia data to the user. At this time, the contents streaming system may include a separate control server, and in this case, the control server performs the role of controlling commands/responses between devices within the contents streaming system.

The streaming server may receive contents from a media storage and/or encoding server. For example, if contents are received from the encoding server, the contents may be received in real-time. In this case, to provide a smooth streaming service, the streaming server may store the bitstream for a predetermined time period.

Examples of the user device may include a mobile phone, smartphone, laptop computer, digital broadcast terminal, personal digital assistant (PDA), portable multimedia player (PMP), navigation terminal, slate PC, tablet PC, ultrabook, wearable device (for example, a smart watch or a smart glass), digital TV, desktop computer, and digital signage. Each individual server within the contents streaming system may be operated as a distributed server, and in this case, data received by each server may be processed in a distributed manner

What is claimed is:

1. An image decoding method performed by a decoding apparatus, the method comprising:
obtaining prediction mode information and residual related information from a bitstream;
deriving prediction samples of a current block by performing prediction based on the prediction mode information;
deriving residual samples of the current block based on the residual related information; and
generating reconstructed samples of the current block based on the prediction samples and the residual samples,
wherein whether the residual related information includes a transform skip flag is determined based on whether the current block is a luma component block or a chroma component block, and
wherein the transform skip flag represents whether a transform skip is applied to the current block.

2. The image decoding method of claim 1, wherein the residual related information includes the transform skip flag for the luma component block based on the current block which is the luma component block.

3. The image decoding method of claim 2, wherein when a non-zero significant coefficient is present in the luma component block, the residual related information includes the transform skip flag for the luma component block.

4. The image decoding method of claim 1, wherein the residual related information does not include the transform skip flag for the chroma component block based on the current block which is the chroma component block.

5. The image decoding method of claim 4, wherein the transform skip flag for the chroma component block is not explicitly signaled based on the current block which is the chroma component block.

6. The image decoding method of claim 1, wherein whether the residual related information includes the transform skip flag is determined based on a prediction mode indicated by the prediction mode information.

7. The image decoding method of claim 6, wherein:
the residual related information includes the transform skip flag for the luma component block and does not include the transform skip flag for the chroma component block based on the prediction mode which is an intra prediction mode, and
the residual related information includes the transform skip flag for the luma component block and the transform skip flag for the chroma component block based on the prediction mode which is an inter prediction mode.

8. The image decoding method of claim 1, wherein the residual related information includes the transform skip flag based on a width and height of the current block.

9. The image decoding method of claim 8, wherein the residual related information includes the transform skip flag based on the width of the current block smaller than or equal to a first threshold and the height of the current block smaller than or equal to a second threshold.

10. The image decoding method of claim 9, wherein:
the first threshold is 32 or 64, and
the second threshold is identical with the first threshold.

11. The image decoding method of claim 9, wherein the current block includes a non-square block.

12. The image decoding method of claim 1, wherein the residual related information includes the transform skip flag based on a number of samples included in the current block.

13. The image decoding method of claim 12, wherein the residual related information includes the transform skip flag based on the number of samples included in the current block smaller than or equal to a third threshold.

14. An image encoding method performed by an encoding apparatus, comprising:
deriving prediction samples by performing prediction on a current block;
deriving residual samples of the current block;
generating reconstructed samples of the current block based on the prediction samples and the residual samples; and
encoding image information including prediction mode information related to the prediction and residual related information related to the residual samples,
wherein whether the residual related information includes a transform skip flag is determined based on whether the current block is a luma component block or a chroma component block, and
the transform skip flag represents whether a transform skip has been applied to the current block.

15. A computer-readable digital storage medium in which a bitstream causing the decoding method of claim 1 to be performed is stored.
